(19) United States
(12) Patent Application Publication
(10) Pub. No.: US 2017/0249701 A1
(43) Pub. Date: Aug. 31, 2017

(54) SYSTEMS, DEVICES, AND METHODS FOR PARALLEL PROCESSING OF FINANCIAL DATA SETS

(71) Applicant: DHANDHO FUNDS LLC, San Juan, PR (US)

(72) Inventor: Mohnish PABRAI, Irvine, CA (US)

(21) Appl. No.: 15/053,654

(22) Filed: Feb. 25, 2016

(51) Int. Cl. G06Q 40/06; G06F 3/0484; H04L 29/06; G06F 17/30

(52) U.S. Cl. CPC G06Q 40/06; G06F 17/30867; G06F 17/30569; G06F 17/30312; G06F 3/0484; H04L 67/42

(57) ABSTRACT

A server is configured for parallel processing. The server receives a plurality of rule sets from a client, retrieves a plurality of financial data sets from a remote data source based on the rule sets, formats the financial data sets in parallel for input into a data structure, and populates the data structure with the financial data sets in parallel without locking the data structure. Subsequently, in response to the server receiving a plurality of event messages from the remote data source, the server processes the event messages and the rule sets, and accordingly modifies the data structure in parallel without locking the data structure, with the event messages relating to the financial data sets.

### TECHNICAL FIELD

Generally, the present disclosure relates to computing. More particularly, the present disclosure relates to parallel processing of financial data sets.

### BACKGROUND

In the present disclosure, where a document, an act and/or an item of knowledge is referred to and/or discussed, then such reference and/or discussion is not an admission that the document, the act and/or the item of knowledge and/or any combination thereof was at the priority date, publicly available, known to the public, part of common general knowledge and/or otherwise constitutes prior art under the applicable statutory provisions; and/or is known to be relevant to an attempt to solve any problem with which the present disclosure is concerned with. Further, nothing is disclaimed.

A financial index is a statistical measurement of value based on a set of securities, such as stocks. Such measurement is often helpful to investors or money managers for tracking performance of the set of securities or a financial market, whether based on a geographical region or an industry sector.

The securities within the financial index may be weighted, and the weighting may be periodically rebalanced. For example, one type of the financial index is a price-weighted index, where a first security is given more weight than a second security based on the first security having a higher price per share than the second security. Another type of the financial index is a market-value index, where a first security is given more weight than a second security based on the first security being associated with a higher market value than the second security. Yet another type of the financial index is an equal-weighted index, wherein a first security is equally weighed to a second security, regardless of price or market value.

Because the financial index is generally based on a single set of securities data, there is a technical challenge in basing the index on a plurality of sets of securities data because of computationally intensive operations, such as data structure maintenance or network signal processing, especially if the sets of securities data contain large amounts of information or if the sets of securities data are processed in real-time during market trading.

### SUMMARY

The present disclosure at least partially addresses at least one of the above drawbacks of conventional systems. However, the present disclosure can prove useful to other technical areas. Therefore, the claims should not be construed as necessarily limited to addressing any of the above.

In one embodiment, a method comprises presenting, by a server, over a local area network, a first graphical user interface in a first application running on a first operating system of a first client, wherein the server comprises a processor comprising a plurality of cores that process in parallel, wherein the first graphical user interface is programmed to receive a plurality of a financial data set identifiers and a plurality of rule sets, wherein the first graphical user interface comprises a control graphical element programmed to trigger a submission of the financial data set identifiers and the rule sets from the client to the server over the local area network, wherein the financial data set identifiers correspond to the rule sets in a one-to-one manner; in response to the submission based on an activation of the control graphical element, populating, by the server, a first data structure with the financial data set identifiers and a second data structure with the rule sets; querying, by the server, over a wide area network, based on the populating, a data source based on accessing, by the server, the rule sets in the second data structure; retrieving, by the server, over the wide area network, a plurality of financial data sets from the data source such that the cores receive the financial data sets in parallel in a one-to-one manner; formatting, by the server, based on the retrieving, the financial data sets via the cores in parallel in a one-to-one manner such that the financial data sets are formatted for input into the first data structure; populating, by the server, based on the formatting, the first data structure with the financial data sets based on the retrieving such that the financial data set identifiers correspond to the financial data sets in a one-to-one manner and such that the cores input the financial data sets in parallel into the first data structure in a one-to-one manner without locking the first data structure; defining, by the server, an index in the first data structure based on the populating the first data structure with the financial data sets, wherein the index is based on the financial data sets, wherein each of the financial data sets comprises a plurality of security identifiers, a plurality of security amounts, and a plurality of security prices, wherein the security identifiers correspond to the security amounts in a one-to-one manner, wherein the security identifiers correspond to the security prices in a one-to-one manner; and in response to receiving, by the server, over the wide area network, after the defining, a plurality of event messages from the data source, interpreting, by the server, the event messages, accessing, by the server, the rule sets in the second data structure, modifying, by the server, the financial data sets in the first data structure based on the rule sets in the second data structure and the event messages as interpreted such that the cores amend the financial data sets in parallel in the first data structure in a one-to-one manner without locking the first data structure and such that the index is updated accordingly, and granting, by the server, over the wide area network, a read access for the index to a second graphical user interface generated by a second application running on a second operating system of a second client, wherein the read access is during the modifying and after the modifying, wherein the financial data sets are related to the event messages via the security identifiers.

In another embodiment, a system comprises a server comprising a processor comprising a plurality of cores which process in parallel, wherein the server is configured to: present, over a local area network, a first graphical user interface in a first application running on a first operating system of a first client, wherein the server comprises a processor comprising a plurality of cores that process in parallel, wherein the first graphical user interface is programmed to receive a plurality of a financial data set identifiers and a plurality of rule sets, wherein the first graphical user interface comprises a control graphical element programmed to trigger a submission of the financial data set identifiers and the rule sets from the client to the server over the local area network, wherein the financial data set identifiers correspond to the rule sets in a one-to-one manner; in response to the submission based on an activation of the control graphical element, populate a first data structure with the financial data set identifiers and a second data structure with the rule sets; query, over a wide area network, based on the populating, a data source based on accessing, by the server, the rule sets in the second data structure; retrieve, over the wide area network, a plurality of financial data sets from the data source such that the cores receive the financial data sets in parallel in a one-to-one manner; format, based on the retrieving, the financial data sets via the cores in parallel in a one-to-one manner such that the financial data sets are formatted for input into the first data structure; populate, based on the formatting, the first data structure with the financial data sets based on the retrieving such that the financial data set identifiers correspond to the financial data sets in a one-to-one manner and such that the cores input the financial data sets in parallel into the first data structure in a one-to-one manner without locking the first data structure; define an index in the first data structure based on the populating the first data structure with the financial data sets, wherein the index is based on the financial data sets, wherein each of the financial data sets comprises a plurality of security identifiers, a plurality of security amounts, and a plurality of security prices, wherein the security identifiers correspond to the security amounts in a one-to-one manner, wherein the security identifiers correspond to the security prices in a one-to-one manner; and in response to receiving, by the server, over the wide area network, after the defining, a plurality of event messages from the data source, interpret the event messages, access the rule sets in the second data structure, modify the financial data sets in the first data structure based on the rule sets in the second data structure and the event messages as interpreted such that the cores amend the financial data sets in parallel in the first data structure in a one-to-one manner without locking the first data structure and such that the index is updated accordingly, and grant, over the wide area network, a read access for the index to a second graphical user interface generated by a second application running on a second operating system of a second client, wherein the read access is during the modifying and after the modifying, wherein the financial data sets are related to the event messages via the security identifiers.

Additional features and advantages of various embodiments are set forth in the description which follows, and in part is apparent from the description. Various objectives and other advantages of the present disclosure are realized and attained by various structures particularly pointed out in the exemplary embodiments in the written description and claims hereof as well as the appended drawings. It is to be understood that both the foregoing general description and the following detailed description are exemplary and explanatory and are intended to provide further explanation of the present disclosure as claimed.

### BRIEF DESCRIPTION OF DRAWINGS

The accompanying drawings constitute a part of this specification and illustrate an embodiment of the present disclosure and together with the specification, explain the present disclosure.

FIG. 1 shows a schematic view of an embodiment of a network topology according to the present disclosure.

FIG. 2 shows a flowchart of an embodiment of a process for parallel processing of financial data sets according to the present disclosure.

FIG. 3 shows a flowchart of an embodiment of a process for populating a data structure based on a plurality of copied records according to the present disclosure.

FIG. 4 shows a schematic view of an embodiment of a multicore processor parallel processing a plurality of financial data sets in a data structure according to the present disclosure.

FIG. 5 shows a schematic view of an embodiment of a database storing a plurality of data structures sourcing an index data structure according to the present disclosure.

FIG. 6 shows a flowchart of an embodiment of a process of operating a server according to the present disclosure.

FIG. 7 shows a flowchart of an embodiment of a process of marking a data structure according to the present disclosure.

FIG. 8 shows a flowchart of an embodiment of a process of editing a data structure according to the present disclosure.

FIG. 9 shows a flowchart of an embodiment of a process of modifying a data structure according to the present disclosure.

### DETAILED DESCRIPTION

The present disclosure is now described more fully with reference to the accompanying drawings, in which embodiments of the present disclosure are shown. The present disclosure may, however, be embodied in many different forms and should not be construed as necessarily being limited to the embodiments disclosed herein. Rather, these embodiments are provided so that the present disclosure is thorough and complete, and fully conveys the concepts of the present disclosure to those skilled in the relevant art.

In some embodiments, a server communicates with a client to receive an input of a plurality of technique names and a plurality of rule sets, with the technique names corresponding to the rule sets in a one-to-one manner. The client is operated by a user. The server comprises a multicore processor with a plurality of cores which process in parallel independent of each other. The server populates a first data structure with the technique names and a second data structure with the rule sets. The server utilizes the rule sets to download a plurality of financial data sets from a data source, remote from the server, such that the cores receive the financial data sets in parallel in a one-to-one manner. Each of the financial data sets comprises a plurality of security symbols, a plurality of security amounts, and a plurality of security prices, with the security symbols corresponding to the security amounts in a one-to-one manner and with the security symbols corresponding to the security prices in a one-to-one manner. The server formats the financial data sets via the cores in parallel in a one-to-one manner such that the financial data sets are formatted for input into the first data structure. The server populates the first data structure with the financial data sets such that the technique names correspond to the financial data sets in a one-to-one manner and such that the cores write the financial data sets in parallel into the first data structure in a one-to-one manner without locking the first data structure. The server defines an index in the first data structure based on the financial data sets. The server receives a plurality of event messages from the data source, interprets the event messages, accesses the rule sets in the second data structure, and modifies the financial data sets in the first data structure based on the rule sets in the second data structure and the event messages as interpreted such that the cores amend the financial data sets in parallel in the first data structure in a one-to-one manner without locking the first data structure and such that the index is updated accordingly, i.e., a rule-based filter to keep/reject a member of a financial data set in the first data structure, with the member participating in defining the index. The server grants a read access for the index to a second client, with the read access being during the modifying of the first data structure and after the modifying of the first data structure.

For example, based on above, the server can implement an algorithm to provide, modify, or maintain a representation in memory of a portfolio comprised of roughly one hundred U.S. stocks and American Depository Receipts (ADRs), which can be selected by three different techniques or approaches that create three distinct data sets based on different attributes. However, note that such portfolio is illustrative and other portfolios can be represented, whether additionally or alternatively. For example, such portfolios can have less than one hundred or more than hundred securities. The three data sets blend into a single portfolio data set or data structure. Constituents of the portfolio can be listed on a U.S. stock exchange directly or through ADRs, and are generally determined without regard to the industries in which such companies operate. The three data sets include: the Cannibal data set (thirty-three companies that have consistently repurchased at least a certain percentage of their outstanding common equity on a recent historical basis), the Spin-Off data set (twenty-five to thirty-three companies that have recently been spun-off from their parent companies), and the Cloning data set (thirty-four companies that are “cloned” from the investment portfolios of select third-party hedge fund managers).

In order to further understand how the server executes the algorithm to identify the initial securities to be marked for purchasing via one or more rule sets, the server employs a “Conception Date” which corresponds to the date with respect to which the server is asked to identify an initial portfolio of constituent securities for each of the three Baskets. The server can accept, as a Conception Date, the first day of any calendar quarter ranging from the current date back to Jul. 1, 1999 (i.e., six months after the last required data stream needed for the algorithm to run—namely Form 13F filings made by hedge fund managers with the U.S. Securities and Exchange Commission and required by the server for populating the Cloning data set—first became publicly available on an electronic basis). However, note that such date is illustrative and the server can be programmed to accept other Conception Dates, including before Jul. 1, 1999. In another embodiment, the server accepts Jul. 1, 1999 as the earliest start date. In another embodiment, the first date can be earlier than Jul. 1, 1999 based on a population of an electronic database with electronic copies of 13-F filings. In another embodiment, if the weighting of the Cloning data set is 0%, then the Conception Date can go as far back as Jan. 1, 1988 because 13-Filings data may be unneeded, although even earlier dates are possible. Note that any of the weightings of the portfolio across the financial data sets via the server can span any point between 0-100%. The server also employs a “Gestation Period” which corresponds to the number of calendar quarters after the Conception Date that the server is allowed to prescribe trade entry and exit points on a hypothetical basis before the resulting portfolio is actually representationally acquired. For instance, based on an analysis of back-testing results, a portfolio with a Gestation Period of 28 quarters prior to its Birth Date (as defined herein) may correlate to an optimum performance after its Birth Date, although even better performances are possible. The server further employs a “Birth Date” which corresponds, for any hypothetical initial portfolio representationally generated by the server, to the date on which the Gestation Period ends and the portfolio of constituent securities in the then still hypothetical portfolio are representationally acquired. Although the initial portfolio of securities can be based on a portfolio with a Birth Date in the first quarter of 2016, a 28 quarter Gestation Period and, working backwards, a Conception Date of Jan. 1, 2009, other dates or time periods can be used. On the Conception Date, the server executes the algorithm to representationally allocate the hypothetical initial portfolio with 75% of the total funds invested in the Cannibal data set, 5% of the total funds in the Spin-Off data set, and 20% in the Cloning data set. However, note that such setup is illustrative and other weightings are possible in any manner. For example, the weightings of these data sets may vary in any combinatory or permutational manner. Stocks within each data set can be equally-weighted as of the Conception Date. The server representationally reconstitutes the portfolio quarterly—on a hypothetical basis prior to its Birth Date and on an actual basis thereafter. After the close of trading on the last trading day of each quarter, the server executes the algorithm to review the constituents in each of the data sets and representationally rebalance the portfolio towards those stocks on the first trading day of the next quarter (each, a “Rebalancing Day”). The server may represent that the portfolio may require several days after a Rebalancing Day to complete the buying and selling for the quarterly rebalancing. The weights of the securities are determined by a pre-programmed sub-algorithm (further detailed herein) for each data set. For purposes of the quarterly rebalancing, each stock's weight can be based on its price as of the close of trading on the last trading date of the most recently completed quarter. The algorithm provides for dividends and proceeds from corporate actions (acquisition, delisting, bankruptcy, spin-off, etc.—also known as “Event Money”) to be representationally reinvested in the portfolio constituents of the respective data set to which the constituent generating the Event Money belongs. The server via the sub-algorithm for each data set generates the list of constituents in which the Event Money has to be invested, as well as the amount that needs to be invested in each constituent. If a company is part of more than one data set then there is an initial investment from both data sets. However, the algorithm ensures that (i) the maximum allocation in any one company does not exceed 3.5% of the total market capitalization of that company, and (ii) the allocation in a single company does not exceed 17% of the total portfolio value. However, note that such configurations are illustrative and the maximum allocation and/or the allocation in the single company can be selectively adjusted in any manner, whether up or down for any purpose. The representative position held in these companies is allowed to temporarily increase up to (i) 4% of the total market capitalization of the company, and (ii) 20% of the total portfolio value, respectively. However, note that such configurations are illustrative and the representative position can be selectively adjusted in any manner, whether up or down for any purpose. The algorithm's approach for each data set is further described below.

For data set 1, i.e. the Cannibal data set, such as a financial data set in a data structure, one rule strategy entails having the server execute the algorithm such that the Cannibal data set include roughly thirty three companies chosen from the universe of companies that (a) have repurchased at least a certain percentage of their shares outstanding within the year prior to the Conception Date (or applicable Rebalancing Day) (“Cannibals”), and (b) have a market capitalization of no less than $1 billion at the Conception Date (or applicable Rebalancing Day). However, note that such configuration is illustrative and the market capitalization can be higher or lower. For example, the market capitalization limit of $1 billion is to ensure that only large-cap companies are considered. However, the minimum market cap limits may vary. If there are more qualifying Cannibals than needed to fill the Cannibal Bucket, the server executes the algorithm to select those with the highest percentage of shares repurchased. The thirty three constituents start as equal weighted hypothetical investments on the Conception Date. The constituents are updated quarterly (on a hypothetical basis prior to the Birth Date and on an actual basis thereafter) as follows. Each company in the Cannibal Bucket enjoys a twelve month minimum holding period. However, note that such minimum holding period is illustrative and other minimum holding periods can be used, whether higher or lower. Following the minimum holding period, a company will be removed from the Cannibal Bucket and replaced with a new Cannibal in the first quarterly rebalancing process during which the server executes the algorithm to identify that the company has increased its shares outstanding over the trailing twelve months. Following being in the Cannibal Bucket for thirty six months, a company will in lieu of the rule described in the previous sentence be removed from the Cannibal Bucket and replaced with a new Cannibal in the first quarterly rebalancing process during which the server executes the algorithm to identify that the company has not reduced its outstanding shares by at least 2% during the previous twelve months or at least 0.3% during the previous three months. However, note that such identification criteria are illustrative and can vary, whether upwards or downwards. The proceeds from the sale of securities when a company is removed from the Cannibal Bucket are allocated: (a) 35% to the remaining Cannibals that have been in the Cannibal Bucket for more than three years (with such allocation equally divided among such remaining Cannibals), (b) 35% to the remaining Cannibals that have been in the Cannibal Bucket between two and three years (with such allocation equally divided among such remaining Cannibals), and (c) 30% to the new Cannibals that enter the Cannibal Bucket on the Rebalancing Day (with such allocation equally divided among new entrants). The allocation percentage for each of the three categories is variable.

With respect to the treatment of event messages for the Cannibal Bucket, such as event money messages, the server executes the algorithm to represent that cash dividends received by the portfolio during a quarter will be invested back into that company that made the dividend until the end of the quarter. Similarly, if a company completes a spin-off during a quarter, the server executes the algorithm to represent that the portfolio will sell the securities it receives in the spun-off company as soon as possible, and the proceeds of such sale will be invested back into the company that completed the spin-off until the end of the quarter. For instance, if a constituent company is delisted or files for bankruptcy, then the server executes the algorithm to represent that the portfolio will sell such company's securities as soon as possible and invest the proceeds in Berkshire Hathaway Class B shares temporarily until the end of the quarter. Similarly, if the server executes the algorithm to represent that the portfolio receives cash and/or securities in connection with the acquisition of a constituent company, then the cash and proceeds from the sale of the received securities (which will be sold by the portfolio as possible) will be invested in Berkshire Hathaway Class B shares temporarily until the end of the quarter. In the first quarterly rebalancing process following any such corporate event, the server executes the algorithm to represent that the event money, such as via event messages, that was temporarily invested in accordance with the rules set forth above, together with any appreciation attributable to such temporary investments, will be liquidated and reallocated to the remaining constituents of the Cannibal Bucket on the Rebalancing Day in the same manner as the proceeds from the removal of former companies that cease to be Cannibals.

With respect to the rebalancing day for the Cannibal data set, the server executes the algorithm to represent that the portfolio constituents are evaluated at the close of last trading day of each quarter and the trading commences on the Rebalancing Day. The server executes the algorithm to represent that the portfolio may require several days after the Rebalancing Day to complete the buying and selling for the rebalancing.

For Bucket 2, i.e., the Spin-Off Bucket, such as a financial data set in a data structure, one rule strategy entails having the server execute the algorithm such that the Spin-Off Bucket includes twenty five to thirty three companies chosen from the universe of companies that (a) were spun-off as public companies from their parent companies between one and seven years prior to the Conception Date (or applicable Rebalancing Day), and (b) have a market capitalization of no less than $500 million at the Conception Date (or applicable Rebalancing Day). However, note that such configuration is illustrative and the market capitalization can be higher or lower. The range of companies to be included in the Spin-Off bucket and their minimum market capitalization requirements are variable. For example, in this context, twenty five to thirty three companies are considered. The entire Spin-Off universe is screened for investment attractiveness based on trailing 12 month earnings and the Spin-Off portfolio consists of the top twenty five to thirty three ranked companies in that ranking. The server executes the algorithm to represent that the initial constituents, anywhere from twenty five to thirty three, start as equal weighted hypothetical investments on the Conception Date. The server executes the algorithm to represent that the constituents are updated quarterly (on a hypothetical basis prior to the Birth Date and on an actual basis thereafter) as follows. The twenty five to thirty three companies are selected based on an automated ranking that ranks each spun-off company based on its age and whether it had positive or negative earnings in the trailing twelve month period; the server executes the algorithm to represent a selection of a sufficient number of companies so that there are at least twenty five constituents and at most thirty three constituents. However, note that such configuration is illustrative and other metrics can be used, such price-earnings ratio or other financial criteria. The server executes the algorithm to represent that the each company in the Spin-off Bucket enjoys a 12 month minimum holding period. However, note that such minimum holding period is illustrative and other minimum holding periods can be used, whether higher or lower. Following the minimum holding period, the server executes the algorithm to represent that a company will be removed from the Spin-Off Bucket and replaced with a new spun-off company in the first quarterly rebalancing process during which the server identifies that the company has negative earnings (on a trailing twelve month basis), if the spin-off date exceeds a specific number of years from the last Rebalancing Day, or if the company is removed for corporate action reasons (e.g., acquisition, delisting, etc.). The proceeds from the sale of securities when a company is removed from the Spin-Off Bucket are allocated: (a) 50% to the remaining companies in the Spin-Off Bucket (with such allocation equally divided among such remaining companies), and (b) 50% to buy stock of the highest ranked company in the spin-off universe that is not yet a constituent of the Spin-Off Bucket. However, note that such allocation criteria are illustrative and can vary, whether upwards or downwards.

With respect to the corporate event allocations for the Spin-Off Bucket, the server executes the algorithm to represent that the cash dividends received by the portfolio during a quarter will be invested back into the company that made the dividend until the end of the quarter. Similarly, if a company in the Spin-Off Bucket completes its own spin-off during a quarter, the server executes the algorithm to represent that the portfolio will sell the securities the portfolio receives in the spun-off company as soon as possible, and the proceeds of such sale will be invested back into the company that completed the spin-off until the end of the quarter. For instance, if a constituent company is delisted or files for bankruptcy, then the server executes the algorithm to represent that the portfolio will sell such company's securities as soon as possible and invest the proceeds in Berkshire Hathaway Class B shares temporarily until the end of the quarter. Similarly, if the portfolio receives cash and/or securities in connection with the acquisition of a constituent company, the cash and proceeds from the sale of the received securities (which will be sold by the portfolio as possible) will be invested in Berkshire Hathaway Class B shares temporarily until the end of the quarter. In the first quarterly rebalancing process following any such corporate event, the server executes the algorithm to represent that the event money that was temporarily invested in accordance with the rules set forth above, together with any appreciation attributable to such temporary investments, will be liquidated and reallocated on the Rebalancing Day as follows: (a) if thirty three constituents remain in the Spin-Off Bucket, then 100% of the event money is in the existing portfolio, and (b) otherwise invest in the same manner as the proceeds from the removal of companies from the Spin-Off Bucket. However, note that such reallocation criteria are illustrative and can vary, whether upwards or downwards.

With respect to the rebalancing day of Spin-Off Bucket, the server executes the algorithm to represent that the portfolio constituents are evaluated at the close of last trading day of each quarter and the trading commences on the Rebalancing Day. The server executes the algorithm to represent that the portfolio may require several days after the Rebalancing Day to complete the buying and selling for the rebalancing.

For Bucket 3, i.e., the Cloning Bucket, such as a financial data set in a data structure, one rule strategy entails having the server execute the algorithm such that the Cloning Bucket includes roughly thirty four companies chosen from the universe of companies that (a) are top holdings of a select group of hedge fund managers as of the Conception Date (or applicable Rebalancing Day), and (b) have a market capitalization of no less than $1 billion at the Conception Date (or applicable Rebalancing Day). However, note that such market capitalization is illustrative and can vary, whether upwards or downwards. The range of companies to be included in the Cloning bucket and their minimum market capitalization requirements are variable. It is considered to be 34 companies in this context, but higher or lower number of companies can be used. The server can download or dynamically update the list of managers from the remote data source, such as over a wide area network. The server executes the algorithm to represent that the list of hedge fund managers is not modified unless the number of hedge fund managers on the list falls below fifteen. Once this occurs, the list can be manually or automatically updated, for example, once per year, during which the server may maintain the list as (a) top-off the list to twenty three managers if the list of managers falls below twenty three managers, and (b) replace up to two hedge fund managers per year on the list. New hedge fund managers that are added must have at least five years of 13-F filings and over $500 million in assets under their management. However, note that such list criteria are illustrative and can vary in any manner. Such fund manager profiles or 13F filings can be selected or accessed based on rules, as disclosed herein.

With respect to the constituents of the Cloning Bucket, the server executes the algorithm to represent that the thirty four constituents start as equal weighted hypothetical investments on the Conception Date. The server executes the algorithm to represent that constituents are updated quarterly (on a hypothetical basis prior to the Birth Date and on an actual basis thereafter) as follows. The server executes the algorithm to represent that once a company enters the Cloning Bucket, the company continues to stay until its rank, based on the dollar value of the hedge fund's investment according to the most recent 13-F filing, drops by more than five in the parent hedge fund's portfolio or is removed from the parent hedge fund's portfolio. However, note that such drop or removal criteria are illustrative and can vary, whether upwards or downwards in any manner. The proceeds from the sale of securities when a company is removed from the Cloning Bucket are allocated 100% to buy stock of the highest ranked company in the cloning universe that is not yet a constituent of the Cloning Bucket.

With respect to the corporate event allocations, the server executes the algorithm to represent that the cash dividends received by the portfolio during a quarter will be invested back into the company that made the dividend until the end of the quarter. Similarly, if a company completes a spin-off during a quarter, the portfolio will sell the securities the portfolio receives in the spun-off company as soon as possible, and the proceeds of such sale will be invested back into the company that completed the spin-off until the end of the quarter. For instance, the server executes the algorithm to represent that if a constituent company is delisted or files for bankruptcy, then the portfolio will sell such company's securities as soon as possible and invest the proceeds in Berkshire Hathaway Class B shares temporarily until the end of the quarter. Similarly, if the portfolio receives cash and/or securities in connection with the acquisition of a constituent company, then the cash and proceeds from the sale of the received securities (which will be sold by the portfolio as possible) will be invested in Berkshire Hathaway Class B shares temporarily until the end of the quarter. The server executes the algorithm to represent that in the first quarterly rebalancing process following any such corporate event, the event money that was temporarily invested in accordance with the rules set forth above, together with any appreciation attributable to such temporary investments, will be liquidated and reallocated on the Rebalancing Day as follows: (a) if 34 constituents remain in the Cloning Bucket, then 100% to the existing stocks in the Cloning Bucket (with such allocation equally divided among such stocks), and (b) otherwise 100% to buy stock of the highest ranked company (or companies) in the cloning universe that are not yet constituents of the Cloning Bucket to bring the number of companies in the Cloning Bucket back to 34. However, note that such reallocation criteria are illustrative and can vary, whether upwards or downwards.

With respect to the rebalancing day of the Cloning Bucket, the server executes the algorithm to represent that the portfolio constituents are evaluated at the close of last trading day of each quarter and the trading commences on the Rebalancing Day. The server executes the algorithm to represent that the portfolio may require several days after the Rebalancing Day to complete the buying and selling for the rebalancing.

As described above, this technology can be implemented via a plurality of computers (servers/clients) utilizing a plurality of data structures/messages. Such implementation includes data structure/message generation, storage, retrieval, population, copying, moving, editing, modifying, sorting, searching, sending, receiving, updating, deleting, encrypting, decrypting, de-duplicating, converting, or any other local or network-based data structure/message operation associated with a structure/message (data shell) or the data itself (content). For example, the structure/message (shell) can comprise a file, a table, a spreadsheet, an array, a matrix, a linked list, a tree, a string, or any others structures of data. For example, the financial data set can be within a file or a table or an array. The data (content) can contain any alphanumeric, image, acoustic, binary, or any other content. For example, the financial data sets and the rules contain the content. Also, note that this algorithm is one non-limiting example and other variations are possible, such as technique names, rule sets, financial data sets, data structures, amount of processing cores, security symbols, security amounts, security prices, formatting, index definitions, event types, event messages, or any other concepts disclosed herein.

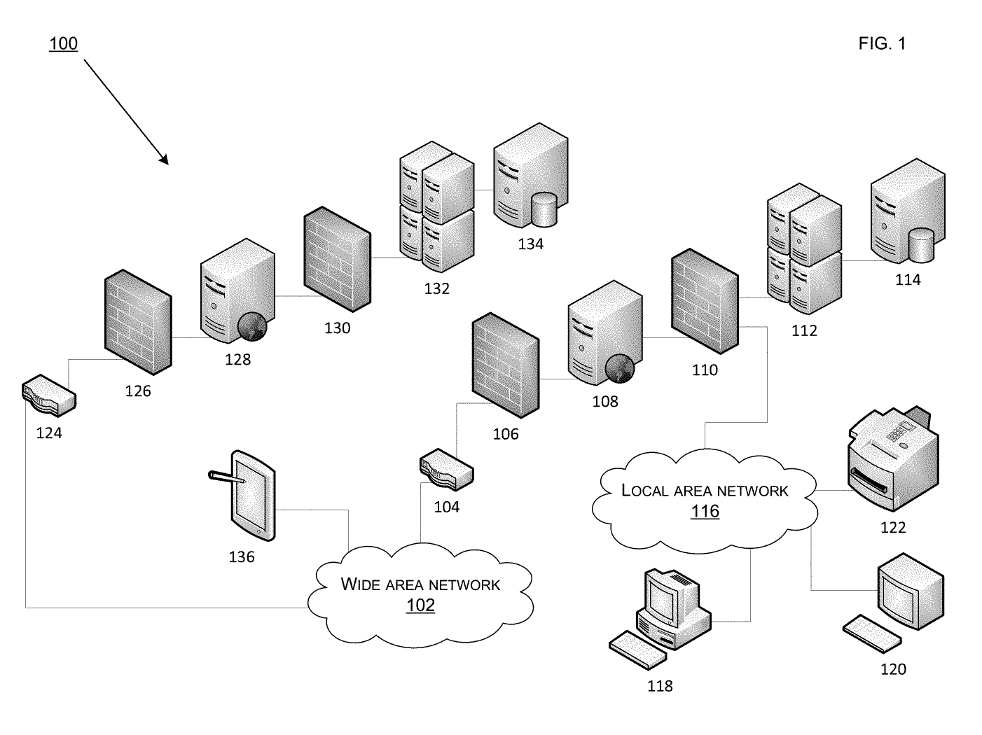

FIG. 1 shows a schematic view of an embodiment of a network topology according to the present disclosure. A network topology 100 comprises a wide area network (WAN) 102 to which a plurality of equipment segments are coupled, whether directly or indirectly, whether in a wired or wireless manner. The segments include a first segment and a second segment. The first segment is operated via a first operator and the second segment is operated via a second operator. The first segment comprises a router 104, a firewall 106, a network server 108, a firewall 110, an application server 112, a database server 114, a local area network (LAN) 116, a workstation 118, an administrator terminal 120, and a multifunction printer 122. The second segment comprises a router 124, a firewall 126, a network server 128, a firewall 130, an application server 132, and a database server 134. The network topology 100 also includes a client 136 communicably coupled to the WAN 102, whether directly or indirectly, whether in a wired or a wireless manner. The client 136 is operated by an end user, such as an investor, a money manager, or a member of general public.

The topology 100 is based on a distributed network operation model, which allocates tasks/workloads between servers, which provide a resource/service, and clients, which request the resource/service. Although the servers and the clients illustrate different computers/applications, in some embodiments, the servers and the clients reside in or share or are one system/application. Further, the topology 100 entails allocating a large number of resources to a small number of servers, where complexity of the clients, depends on how much computation is offloaded to the small number of servers, i.e., more computation offloaded from the clients onto the servers leads to lighter clients, such as being more reliant on network sources and less reliant on local computing resources. However, note that other computing models are possible as well. For example, such models can comprise decentralized computing, such as peer-to-peer (P2P), for instance Bit-Torrent, or distributed computing, such as via a computer cluster where a set of networked computers works together such that the computer can be viewed as a single system.

Each component of the topology 100 can be implemented in a logic, whether hardware-based or software-based. For example, when the logic is hardware-based, then such logic can comprise circuitry, such as processors, memory, input devices, output devices, or other hardware, that is configured, such as via programming or design, to implement a functionality of a respective component. Likewise, when the logic is software-based, then such logic can comprise one or more instructions, such as assembly code, machine code, object code, source code, or any other type of instructions, which when executed, such as via running or compilation, implement a functionality of a respective component.

The WAN 102 is communicably interposed between the first segment and the second segment. The WAN 102 can be operated via the first operator, the second operator, or a third operator. The WAN 102 can be established via a telecommunication circuit. The WAN 102 can comprise circuit switching or packet switching methods. The WAN 102 can employ network protocols including Transmission Control Protocol (TCP)/Internet Protocol (IP), which can be used deliver transport and addressing functions. The WAN 102 can comprise circuit switched telephone lines, radio wave transmission, or optic fiber. In some embodiments, the first segment and the second segment communicably interface with each other, while avoiding the WAN 102, such via direct communication, such as via the router 104 and the router 124.

Although the first segment is organized in a dual firewall configuration, the first segment can also be organized in a single firewall configuration, such as a three legged network model. The router 104 is communicably interposed between the WAN 102 and the firewall 106. The firewall 106 is communicably interposed between the router 104 and the network server 108. The network server 108 is communicably interposed between the firewall 106 and the firewall 110. For example, a demilitarized zone or a perimeter network can be formed, where the network server 108 is positioned therein. The firewall 110 is communicably interposed between the application server 112 and the network server 108. The firewall 110 is communicably interposed between the LAN 116 and the network server 108. The application server 112 is communicably interposed between the firewall 110 and the database server 114. The LAN 116 is communicably coupled to the workstation 118, the administrator terminal 120, and the multifunction printer 122. Note that communicative interpositioning and communicative coupling can be direct or indirect, whether wired or wireless.

Although the second segment is also organized in a dual firewall configuration, the second segment can also be organized in a single firewall configuration, such as a three legged network model. The router 124 is communicably interposed between the WAN 102 and the firewall 126. The firewall 126 is communicably interposed between the router 124 and the network server 128. The network server 128 is communicably interposed between the firewall 126 and the firewall 130. For example, a demilitarized zone or a perimeter network can be formed, where the network server 128 is positioned therein. The firewall 130 is communicably interposed between the network server 128 and the application server 132. The application server 132 is communicably interposed between the firewall 130 and the database server 134. Note that communicative interpositioning and communicative coupling can be direct or indirect, whether wired or wireless.

The routers 104, 124 forward data packets from the WAN 102 to the firewalls 106, 126, respectively, and vice versa. The routers 104, 124 can be identical or different from each other in structure or operation.

Each of the firewalls 106, 110, 126, 130 is a network security system which monitors and controls incoming and outgoing network traffic based on a set of security rules. Each of the firewalls 106, 110, 126, 130 can be a network firewall or a host-based firewall. Each of the firewalls 106, 110, 126, 130 can be identical or different from each other in structure or operation.

The network servers 108, 128 serve content, such as a network page, to the application servers 112, 132, respectively, in response receiving a corresponding request. The network server 108 serves content, such as a network page, to the workstation 118, the administrator terminal 120, and the multifunction printer 122 over the LAN 116 in response receiving a corresponding request. Such service can be via a protocol, such as HTTP. For example, the network pages are file-based and can be static or dynamically generated, such as Hypertext Transfer Markup Language (HTML). For example, at least one of the network servers 108, 128 is a web server, such as Apache, Microsoft's Internet Information Server (IIS), Novell's NetWare server, Google Web Server (GWS), or IBM Domino server.

Each of the application servers 112, 132 hosts a software application and a set of business logic for the software application, such as a set of rules. Therefore, as instructed by respective software applications, the application servers 112, 132 communicably interface with the network servers 108, 128 through the firewalls 110, 130, respectively, and the database servers 114, 134, respectively. For example, at least one of the application servers 112, 132 can act as a middle-tier server, with the network servers 108, 128 acting as front-tier servers, and the database servers 114, 134 acting as back-end servers. For example, at least one of the application servers 112, 132 can be an IBM Web Sphere application server or a SAP Web application server.

Each of the application servers 112, 132 comprises a plurality of independent cores, such as a multicore processor comprising a computing component with two or more independent processing units, which are the units that read and execute program instructions, such as via multiprocessing or multithreading. The instructions are processing instructions, such as add, move data, or branch, but the cores can run multiple instructions concurrently, thereby increasing an overall operational speed for the software application, which is amenable to parallel computing. The cores can process in parallel when concurrently accessing a file or any other data structure, as disclosed herein, while being compliant with atomicity, consistency, isolation, and durability (ACID) principles, which ensure that such data structure operations/transactions, such as read, write, erase, or others, are processed reliably. For example, a data structure can be accessed, such as read or written, via at least two cores concurrently, where each of the cores concurrently processes a distinct data structure record or a distinct set of financial data such that at least two data structure records or at least two sets of the financial data are processed concurrently, without locking the data structure between such cores. Note that there can be at least two cores, such as two cores, three cores, four cores, six cores, eight cores, ten cores, twelve cores, or more. The cores may or may not share caches, and the cores may or may not implement message passing or shared-memory inter-core communication methods. Common network topologies to interconnect cores include bus, ring, two-dimensional mesh, and crossbar. Homogeneous multi-core systems include only identical cores, heterogeneous multi-core systems can have cores that are not identical. The cores in multi-core systems may implement architectures, such as very long instruction word (VLIW), superscalar, vector, or multithreading.

Each of the database servers 114, 134 hosts a database, such as a relational database, a non-relational database, an in-memory database, or others. The database stores data, whether in a raw state, a formatted state, an organized stated, or any other accessible state, and allows access to such data, whether directly and/or indirectly. Each of the database servers 114, 134 is configured for various database input (I)/output (O) operations, including reading, writing, editing, deleting, updating, searching, selecting, merging, sorting, erasing, formatting, or others. Each of the database servers 114, 134 can implement record locking on the respective database. For example, the database can be an Oracle database, a MS-SQL database, or a DB2 database.

The workstation 118 is programmed to run an application on an operating system (OS), such as Windows, Linux, Android, MacOS, and/or others. The application is programmed to display a graphical user interface (GUI), as disclosed herein. The GUI is programmed to receive an input and display an output. The input comprises an identifier, such as a technique name, and a rule, as disclosed herein. The input is from a user, such as a financial services professional, trader, money manager, or investor. The output comprises the identifier, a financial data set associated with the identifier, and an index, as disclosed herein. However, note that the GUI can receive and display other relevant financial information as well, as disclosed herein. The workstation 118 is configured to print a report from the multifunction printer 122, such as in color or grayscale.

The workstation 118 communicates the input to application server 112 via the LAN 116 and the firewall 110. In response, the application server 112 performs data operations, as disclosed herein, such as automatically retrieves a plurality of financial data sets from the application server 132 over the WAN 102.

The administrator terminal 120 is programmed to allow maintenance or troubleshooting of the first segment, such as the router 104, the firewall 106, the network server 108, the firewall 110, the application server 112, the database server 114, the LAN 116, the workstation 118, and the multifunction printer 122. Such maintenance or troubleshooting can involve trading settings, rule amendments/tweaks, data structure maintenance, software updates, debugging, access control, simulation, event logging, event monitoring, automation, or others.

The client 136 is a tablet computer. However, note that the client 136 can be any type of a computer, such as a desktop, a laptop, a phone, a vehicle, or any other suitable computer.

Note that any of the servers disclosed herein can be hardware-based and/or software-based. Each of the servers is and/or is hosted on, whether directly and/or indirectly, a server computer, whether stationary or mobile, such as a kiosk, a workstation, a vehicle, whether land, marine, or aerial, a desktop, a laptop, a tablet, a mobile phone, a mainframe, a supercomputer, a server farm, and so forth. The server computer can comprise another computer system and/or a cloud computing network. The server computer can run any type of an OS, such as MacOS, Windows, Android, Unix, Linux, and/or others. The server computer can include and/or be coupled to, whether directly and/or indirectly, an input device, such as a mouse, a keyboard, a touchscreen, a biometric reader, a clicker, a microphone, or any other suitable input device. The server computer can include and/or be coupled to, whether directly and/or indirectly, an output device, such as a display, a speaker, a printer, or any other suitable output device. In some embodiments, the input device and the output device can be embodied in one unit, such as a touch-enabled display, which can be haptic. Each of the servers can employ load-balancing technologies and/or failover technologies for operational efficiency, continuity, and/or redundancy. Each of the servers can be task-dedicated. At least two of the servers can be a single server.

Note that the clients disclosed herein can be hardware-based and/or software-based. Each of the clients is and/or is hosted on, whether directly and/or indirectly, a client computer, whether stationary or mobile, such as a terminal, a kiosk, a workstation, a vehicle, whether land, marine, or aerial, a desktop, a laptop, a tablet, a mobile phone, a mainframe, a supercomputer, a server farm, and so forth. The client computer can comprise another computer system and/or cloud computing network. The client computer can run any type of an OS, such as MacOS, Windows, Android, Unix, Linux, and/or others. The client computer can include and/or be coupled to an input device, such as a mouse, a keyboard, a camera, an accelerometer, a touchscreen, a biometric reader, a clicker, a microphone, or any other suitable input device. The client computer can include and/or be coupled to an output device, such as a display, a speaker, a joystick, a printer, or any other suitable output device. In some embodiments, the input device and the output device can be embodied in one unit, such as a touch-enabled display, which can be haptic.

In one mode of operation, the application server 112 is configured for parallel processing. The application server 112 receives a plurality of rule sets from the workstation 118, retrieves a plurality of financial data sets from the application server 132 based on the rule sets, formats the financial data sets in parallel for input into a data structure, and populates the data structure with the financial data sets in parallel without locking the data structure. Subsequently, in response to the application server 112 receiving a plurality of event messages from the application server 132, the application server 112 processes the event messages and the rule sets, and accordingly modifies the data structure in parallel without locking the data structure, with the event messages relating to the financial data sets.

For example, the application server 112 can serve or present, over the LAN 116, a GUI in an application, such as a browser, running on an operating system of the workstation 118. The application server 112 comprises a processor comprising a plurality of cores which process in parallel. The GUI is programmed to receive, such as via an input from a user, a plurality of a financial data set identifiers, such as technique or data set names, and a plurality of rule sets, such as disclosed herein. The financial data set identifiers correspond to the rule sets in a one-to-one manner, such as a single technique or data set name corresponding to a single rule set. The application server 112 receives, over the LAN 116, based on the serving or the presenting, the financial data set identifiers and the rule sets from the workstation 118, such as upon a submission of a form upon population of a plurality of fields of the form. The application server 112 populates a first data structure, such as a file or a table or an array, with the financial data set identifiers and a second data structure, such as a file or a table or an array, with the rule sets. The application server 112 accesses the rule sets in the second data structure. The application server 112 queries, over the WAN 102, based on the populating, the application server 132. The application server 112 retrieves, over the WAN 102, a plurality of financial data sets from the application server 132 such that the cores receive the financial data sets in parallel in a one-to-one manner. Note that the application server 132 can obtain the financial data sets from the database server 134 or the application server 132 can host the financial data sets. Further, note that the financial data sets can travel from the application server 132 to the application server 112 through the firewall 130, the network server 128, the firewall 126, the router 124, the WAN 102, the router 104, the firewall 106, the network server 108, and the firewall 110, in an encrypted or an unencrypted state, whether raw or formatted. The application server 112 formats based on the retrieving, the financial data sets via the cores in parallel in a one-to-one manner such that the financial data sets are formatted for input into the first data structure. The application server 112 populates, based on the formatting, the first data structure with the financial data sets based on the retrieving such that the financial data set identifiers correspond to the financial data sets in a one-to-one manner and such that the cores input the financial data sets in parallel into the first data structure in a one-to-one manner without locking the first data structure. The application server 112 defines an index in the first data structure based on the populating the first data structure with the financial data sets. The index is based on the financial data sets. For example, the index is or comprises a statistical measurement of value based on the financial data sets. Note that each of the financial data sets comprises a plurality of security identifiers, such as a plurality of security symbols, for instance ticker symbols, a plurality of security amounts, such as a number of securities, for instance ten shares, and a plurality of security prices, such as $10 per share. The security identifiers correspond to the security amounts in a one-to-one manner, such as a single ticker symbol corresponds to a single number of securities. The security identifiers correspond to the security prices in a one-to-one manner, such as a single ticker symbol corresponds to a share price. The application server 112 receives, over the WAN 102, after the defining, a plurality of event messages from the data source. The financial data sets are related to the event messages via the security identifiers. The event message can be informative of one or more events associated with one or more security identifiers. For example, an event can be a dividend, a split, a bankruptcy, a delisting, or any other information relevant to an owner or a trader of a security associated with that security symbol. Note that the application server 132 can receive the event messages from the database server 134 or the application server 132 can host the financial data sets. Further, note that the event messages can travel from the application server 132 to the application server 112 through the firewall 130, the network server 128, the firewall 126, the router 124, the WAN 102, the router 104, the firewall 106, the network server 108, and the firewall 110, in an encrypted or an unencrypted state, whether raw or formatted. Also, note that the event messages can be pushed by the application server 132 or pulled by the application server 112. The application server 112 interprets the event messages, accesses the rule sets in the second data structure, and modifies the financial data sets in the first data structure based on the rule sets in the second data structure and the event messages as interpreted such that the cores amend the financial data sets in parallel in the first data structure in a one-to-one manner without locking the first data structure and such that the index is updated accordingly. The application server 112 grants, over the WAN 102, a read access for the index to the client 136. The read access is during the modifying and after the modifying.

Note that the application server 112 generate a report based on the financial data set identifiers and the financial data sets in the first data structure after the populating the first data structure with the financial data sets. For example, the report can comprise a table organized by the financial data set identifiers, where each of the financial data set identifiers identifying at least a portion of a relevant financial data set. The report can be printed by the multifunction printer 122. The application server 112 can serve or present the report to at least one of the workstation 118 over the LAN 102 or the client 136 over the WAN 102. The application server 112 can update the report dynamically on at least one of the workstation 118 over the LAN 102 or the client 136 over the WAN 102 based on the modifying during the presenting. For example, when the report is displayed, the application server 112 can be updating the report, in real-time, during market trading, as the first data structure is being modified in parallel by the cores without locking the data structure.

Note that a scenario is possible that the financial data sets do not have a security identifier in common during at least one of the defining or the modifying.

Note that the cores can be dedicated to processing the financial data sets in a one-to-one manner during at least one of the retrieving, the populating the first data structure with the financial data sets, or the modifying. For example, the application server 112 contains a multicore processor with a first core and second core, where the first core is exclusively dedicated to processing the first financial data set and the second core exclusively dedicated to processing the second financial data set. Such dedication can occur via the application running on the application server 112, such as upon receipt of the first financial data set and the second financial data set.

Note that the application server 112 can be enabled to allow the modifying of the first data structure to comprise replacing an original member of at least one of the financial data sets with a new member, such as based on an event message, as interpreted, and a rule, as applied.

Note that the application server 112 can be configured to provide a plurality of read accesses, such as when the read access is a first read access. For example, based on the application server 112 defining the index, the application server 112 can generate a third data structure comprising the financial data set identifiers and the financial data sets obtained from the first data structure, such as via copying. The financial data set identifiers in the third data structure correspond to the financial data sets in a one-to-one manner. The third data structure can represent a real-world portfolio, such as an exchange traded fund (ETF) based on the index, as accessed via the first read access. The application server 112 can modify, based on the generating of the third data structure, at least one of the financial data sets in the third data structure based on a change in at least one of the financial data sets the first data structure based on the rule sets in the second data structure and the event messages as interpreted. Such modification can be via mirroring or copying. The application server 112 can grant, over the WAN 102, a second read access to the client 136, such as when the end user of the client 136 is associated with or a trader of or an owner of the real-world portfolio. The second read access is for the third data structure.

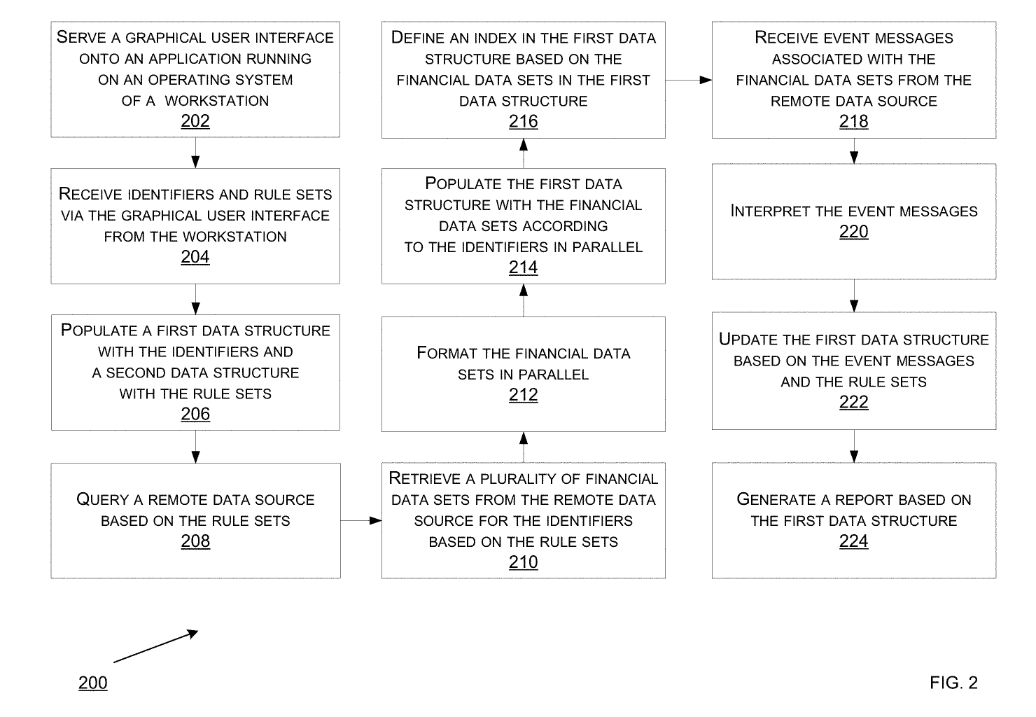

FIG. 2 shows a flowchart of an embodiment of a process for parallel processing of financial data sets according to the present disclosure. A process 200 includes a plurality of blocks 202-224. The process 200 can be performed via the topology 100 of FIG. 1. As noted above, the application server 112 comprises a processor comprising a plurality of cores which process in parallel.

In a block 202, the application server 112 serves, such as via presenting, a GUI onto an application running on an OS of the workstation 118. The application can be a trading application, a spreadsheet application, a network browser application, a social network application, a simulation application, or any other software application. The GUI is programmed to receive, such as via an input from a user, a plurality of a financial data set identifiers, such as technique or data set names, and a plurality of rule sets, such as disclosed herein. The GUI can be of any type, such as a form or a network page, and can include any fields, such as text fields, or visual elements, such as dials, drop-down menus, buttons, hyperlinks, checkboxes, sliders, or other control elements. For example, the visual element, such as a button, can dynamically change from inactive or invisible to active or visible based on proper input, such as a rule compliant with a preset rule format. Alternatively or additionally, the input can touch-based or microphone-based or image-based. Alternatively or additionally, the input can be in a natural language form, such as in a sentence or sound or image, where such input can be subsequently processed via the application server 112 implementing a natural language processing algorithms, such as based on statistical model machine learning. For example, such algorithms can involve automatic summarization, co-reference resolution, discourse analysis, machine translation, morphological segmentation, named entity recognition (NER), native language identification, natural language generation, natural language understanding, optical character recognition (OCR), part-of-speech tagging, parsing, question answering, relationship extraction, sentence breaking, sentiment analysis, speech recognition, speech segmentation, stemming, topic segmentation and recognition, word segmentation, word sense disambiguation, or others. The financial data set identifiers correspond to the rule sets in a one-to-one manner, such as a single technique or data set name corresponding to a single rule set. The financial data set identifiers can be in any human language in any font or via any pictorial or sound representation, such as a string, an icon, a banner, an audio, a video, or a photo.

In a block 204, the application server 112 receives the financial data set identifiers and the rule sets from the GUI of the application running on the OS of the workstation 118, such as upon a submission of a form upon population of a plurality of fields of the form. Such receipt can be via a single data structure, such as file, or a plurality of data structure, such as a plurality of files.

In a block 206, the application server 112 populates a first data structure, such as a file or a table or an array, with the financial data set identifiers and a second data structure, such as a file or a table or an array, with the rule sets. Such population is via modifying the first data structure and the second data structure, such as via writing.

In a block 208, the application server 112 queries a remote data source based on the rule sets. Such querying is via the application server 112 accessing the rule sets in the second data structure. The remote data source can be the application server 132. For example, such query can be via a standard query language (SQL) message.

In a block 210, the application server 112 retrieves a plurality of financial data sets from the application server 132 such that the cores receive the financial data sets in parallel in a one-to-one manner. Note that the application server 132 can obtain the financial data sets from the database server 134 or the application server 132 can host the financial data sets.

In a block 212, the application server 112 formats the financial data sets via the cores in parallel in a one-to-one manner such that the financial data sets are formatted for input into the first data structure. For example, if the application server 132 served the financial data sets in a first format, then the application server 112 can convert the financial data sets from the first format into a second format, such as for data structure or processor compatibility or computational efficiency. For the example, the first format in a first character-encoding scheme and the second format can be in a second character-encoding scheme. For example, the first format can an archive or zipped file and the second format can be un-archived or unzipped file.

In a block 214, the application server 112 populates the first data structure with the financial data sets such that the financial data set identifiers correspond to the financial data sets in a one-to-one manner and such that the cores input the financial data sets in parallel into the first data structure in a one-to-one manner without locking the first data structure. Note that each of the financial data sets comprises a plurality of security identifiers, such as a plurality of security symbols, for instance ticker symbols, a plurality of security amounts, such as a number of securities, for instance ten shares, and a plurality of security prices, such as $10 per share. The security identifiers correspond to the security amounts in a one-to-one manner, such as a single ticker symbol corresponds to a single number of securities. The security identifiers correspond to the security prices in a one-to-one manner, such as a single ticker symbol corresponds to a share price.

In a block 216, the application server 112 defines an index in the first data structure based on the financial data sets in the first data structure. The index is based on the financial data sets. For example, the index is or comprises a statistical measurement of value based on the financial data sets.

In a block 218, the application server 112 receives a plurality of event messages from the data source. The financial data sets are related to the event messages via the security identifiers. The event message can be informative of one or more events associated with one or more security identifiers. For example, an event can be a dividend, a split, a bankruptcy, a delisting, or any other information relevant to an owner or a trader of a security associated with that security symbol. Note that the application server 132 can receive the event messages from the database server 134 or the application server 132 can host the financial data sets. Also, note that the event messages can be pushed by the application server 132 or pulled by the application server 112.

In a block 220, the application server 112 interprets the event messages. Such interpretation can be as preset for such messages in advance or via natural language processing algorithms are disclosed herein. For example, if a format of an event message is known in advance, then the application server 112 can be programmed to understand such format, extract data from the event message, process the data, and analyze the data such that a content interpretation takes place.

In a block 222, the application server 112 updates the first data structure based on the event messages and the rule sets. For example, the application server 112 accesses the rule sets in the second data structure and modifies, such as via editing through writing, the financial data sets in the first data structure based on the rule sets in the second data structure and the event messages as interpreted such that the cores amend the financial data sets in parallel in the first data structure in a one-to-one manner without locking the first data structure and such that the index is updated accordingly. The application server 112 can grant a read access for the index to the client 136, with the read access being during the modifying and after the modifying.

In a block 224, the application server 112 generates a report based on the first data structure, such as based on the financial data set identifiers and the financial data sets in the first data structure after the populating the first data structure with the financial data sets. For example, the report can comprise a table organized by the financial data set identifiers, where each of the financial data set identifiers identifying at least a portion of a relevant financial data set. The report can be printed by the multifunction printer 122. The application server 112 can serve or present the report to at least one of the workstation 118 over the LAN 102 or the client 136 over the WAN 102. The application server 112 can update the report dynamically on at least one of the workstation 118 over the LAN 102 or the client 136 over the WAN 102 based on the modifying during the presenting. For example, when the report is displayed, the application server 112 can be updating the report, in real-time, during market trading, as the first data structure is being modified in parallel by the cores without locking the data structure.

In some embodiments, a scenario is possible that the financial data sets do not have a security identifier in common during at least one of the defining or the modifying. Also, the cores can be dedicated to processing the financial data sets in a one-to-one manner during at least one of the retrieving, the populating the first data structure with the financial data sets, or the modifying. For example, the application server 112 contains a multicore processor with a first core and second core, where the first core is exclusively dedicated to processing the first financial data set and the second core exclusively dedicated to processing the second financial data set. Such dedication can occur via the application running on the application server 112, such as upon receipt of the first financial data set and the second financial data set. The application server 112 can be enabled to allow the modifying of the first data structure to comprise replacing an original member of at least one of the financial data sets with a new member, such as based on an event message, as interpreted, and a rule, as applied. The application server 112 can be configured to provide a plurality of read accesses, such as when the read access is a first read access. For example, based on the application server 112 defining the index, the application server 112 can generate a third data structure comprising the financial data set identifiers and the financial data sets obtained from the first data structure, such as via copying. The financial data set identifiers in the third data structure correspond to the financial data sets in a one-to-one manner. The third data structure can represent a real-world portfolio, such as an ETF based on the index, as accessed via the first read access. The application server 112 can modify, based on the generating of the third data structure, at least one of the financial data sets in the third data structure based on a change in at least one of the financial data sets the first data structure based on the rule sets in the second data structure and the event messages as interpreted. Such modification can be via mirroring or copying. The application server 112 can grant, over the WAN 102, a second read access to the client 136, such as when the end user of the client 136 is associated with or a trader of or an owner of the real-world portfolio. The second read access is for the third data structure.

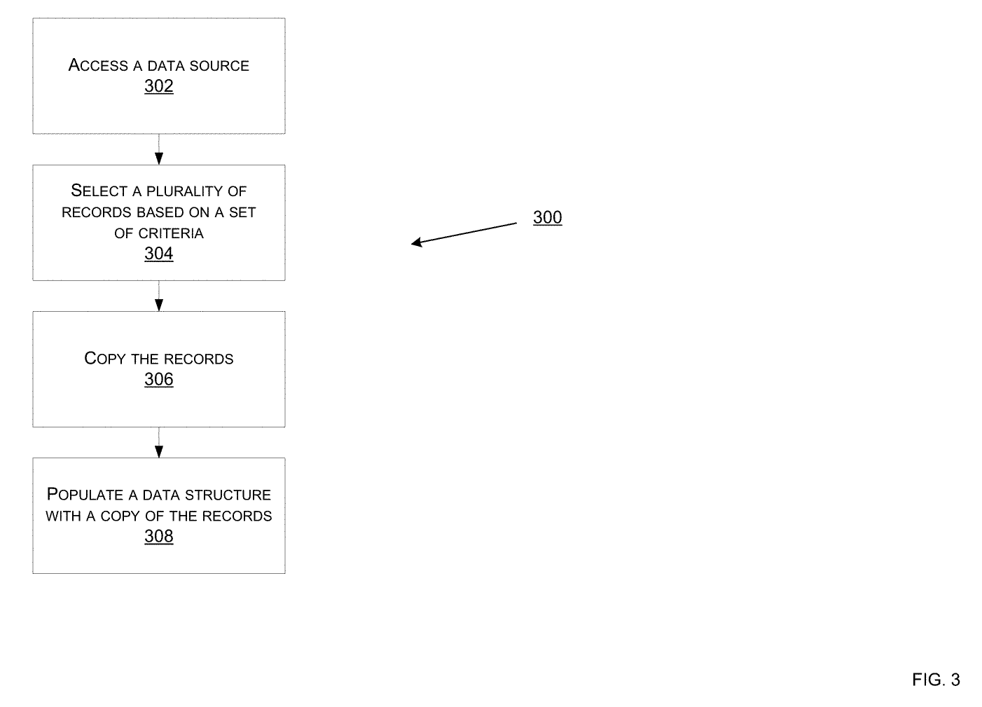

FIG. 3 shows a flowchart of an embodiment of a process for populating a data structure based on a plurality of copied records according to the present disclosure.

A process 300 includes a plurality of blocks 302-308. The process 300 can be performed via the topology 100 of FIG. 1 and can be a portion of the process 200 of FIG. 2. As noted above, the application server 112 comprises a processor comprising a plurality of cores which process in parallel.

In a block 302, the application server 112 accesses a data source. For example, the application server 112 communicably interfaces with the data source, such as via sending a request to open a network port for access or a browsing request or a packet request or a page request or a file request or a record request. The remote data source can be the application server 132.

In a block 304, the application server 112 selects a plurality of records based on a set of criteria. For example, such selection can be based on the application server 112 generating a message based on the rule sets stored in the second data structure and sending the message to the data source. The message can contain at least a portion of the set of criteria. In response to receiving the message and processing the message, if the data source hosts or has access to a database storing the records, then a database management system (DBMS) managing the database acts based on the message, such as the set of criteria, to select the records. Note that the DBMS can be modifying, in real-time, the database storing the records based on other information, such as market trading. The records contain financial data, such as disclosed herein, such as a plurality of security identifiers, such as a plurality of security symbols, for instance ticker symbols, a plurality of security amounts, such as a number of securities, for instance ten shares, and a plurality of security prices, such as $10 per share. The security identifiers correspond to the security amounts in a one-to-one manner, such as a single ticker symbol corresponds to a single number of securities. The security identifiers correspond to the security prices in a one-to-one manner, such as a single ticker symbol corresponds to a share price. The records can correspond to the financial data sets in a one-to-one manner, as pre-generated. For example, three records can correspond to three financial data sets. Additionally or alternatively, the records can also correspond to a plurality of data items for a plurality of securities, where the application server 132 builds the financial data sets based on the data items.

In a block 306, the application server 112 copies the records. For example, such copying is based on the records selected by the application server 112. The copying can be on a financial data set basis, as pre-generated, or a data item basis, such as copying five records for five securities described therein.

In a block 308, the application server 112 populates a data structure with a copy of the records. For example, the application server 112 retrieves a plurality of financial data sets from the application server 132 such that the cores receive the financial data sets in parallel in a one-to-one manner. The application server 112 formats the financial data sets via the cores in parallel in a one-to-one manner such that the financial data sets are formatted for input into the first data structure. For instance, if the application server 132 served the financial data sets in a first format, then the application server 112 can convert the financial data sets from the first format into a second format in parallel, such as for data structure or processor compatibility or computational efficiency. For the example, the first format in a first character-encoding scheme and the second format can be in a second character-encoding scheme. For example, the first format can an archive or zipped file and the second format can be un-archived or unzipped file. The application server 112 inputs the financial data sets into the first data structure such that the financial data set identifiers correspond to the financial data sets in a one-to-one manner and such that the cores input the financial data sets in parallel into the first data structure in a one-to-one manner without locking the first data structure.

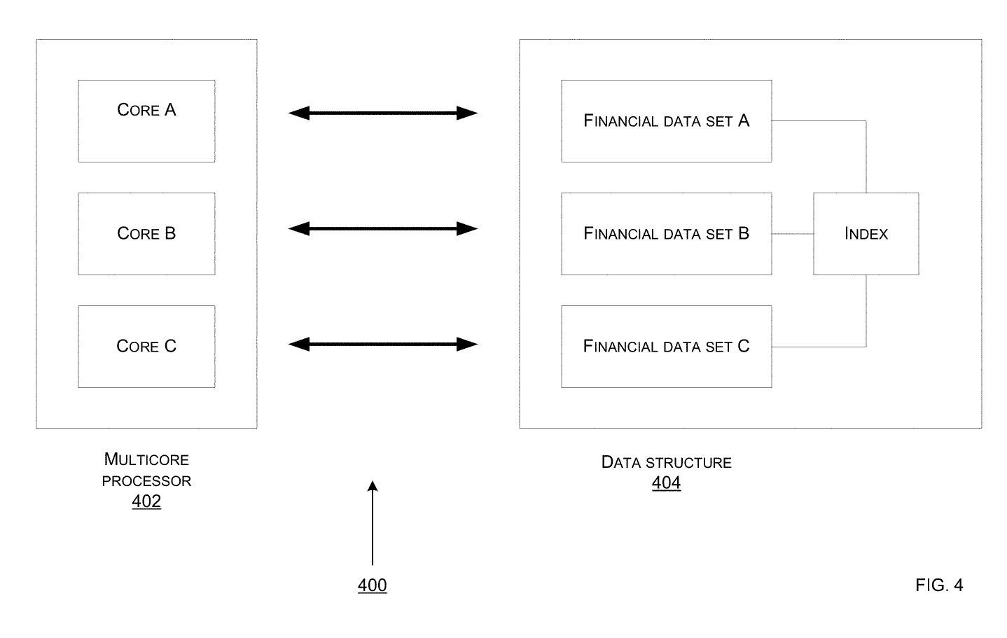

FIG. 4 shows a schematic view of an embodiment of a multicore processor parallel processing a plurality of financial data sets in a data structure according to the present disclosure. The application server 112 comprises a multicore processor 402 and a data structure 404.

The multicore processor 402 comprises a plurality of cores, such as a core A, a core B, and a core C. However, note that other multicore configurations are possible, such as at least two cores.

The data structure 404, such as a file, a table, a spreadsheet, an array, a matrix, a linked list, a tree, or others, contains a plurality of financial data sets, such as a financial data set A, a financial data set B, and a financial data set C, and an index. However, note that other data structure configurations are possible, such as at least two financial data sets. In the data structure 404, the financial data sets are independent of each other, however dependency can be possible in other embodiments. In the data structure 404, the financial data sets function as a source for the index, which is based on at least two of the financial data sets. For example, the financial data sets and the index can be embodied via a linked list within the data structure 404, where the index links to the financial data sets, such as for data sourcing. Also for example, the financial data sets and the index can be embodied via a tree within the data structure 404, where the financial data sets branch to the index, such as for data sourcing.

The cores of the multicore processor 402 independently process in parallel the financial data sets in the data structure 404 in a one-to-one manner, such as the core A processes the financial data set A and the core B processes the financial data set B in parallel and independent of the core A, without locking the data structure 404 for ACID principles. For example, the cores of the multicore processor 402 can format the financial data sets in parallel for input into the data structure 404 and populate the data structure 404 with the financial data sets such that the financial data set identifiers in the data structure 404 correspond to the financial data sets in a one-to-one manner and such that the cores input the financial data sets in parallel into the data structure 404 in a one-to-one manner, without locking the data structure 404. Subsequently, the index is defined in the data structure 404 based on such populating, with the index being based on the financial data sets. For example, a financial data set identifier and a financial data set can be within a single node of the linked list or the tree or be separately located or structured within the data structure 404. For example, a financial data set identifier and a financial data set can form a single data unit within the data structure 404 or a financial data set identifier and a financial data set are in different data units within the data structure 404.

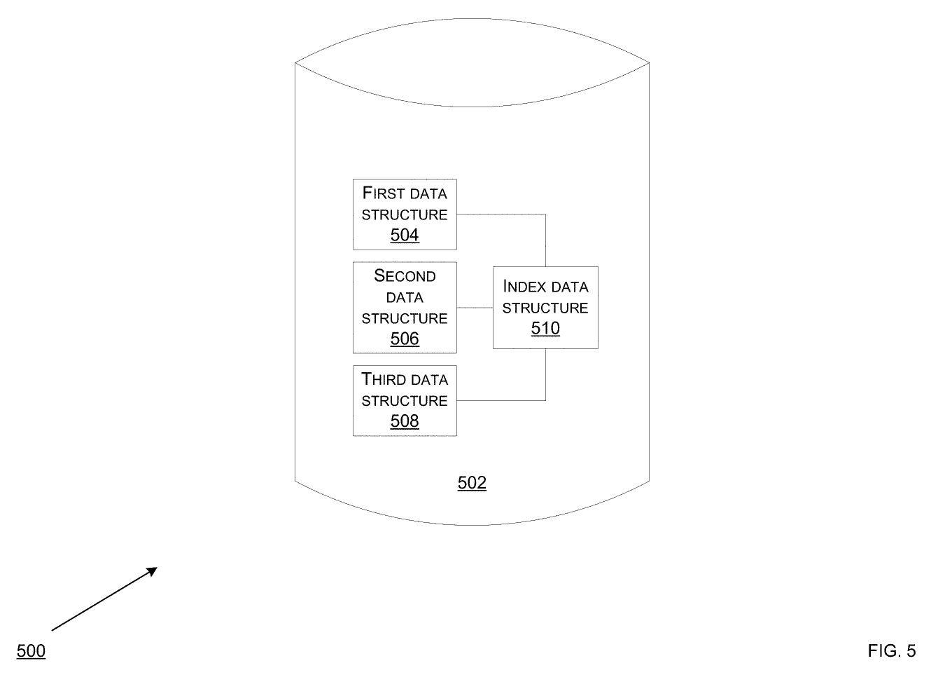

FIG. 5 shows a schematic view of an embodiment of a database storing a plurality of data structures sourcing an index data structure according to the present disclosure. A database 502 stores a first data structure 504, a second data structure 506, a third data structure 508, and an index data structure 510. The database 502 can be hosted via the application server 112 or the database server 114. Each of the first data structure 504, the second data structure 506, the third data structure 508, and an index data structure 510 can be a file, a table, a spreadsheet, an array, a matrix, a linked list, a tree, a string, or any others structures of data. Each of the first data structure 504, the second structure 506, and the third data structure 508 stores a financial data set identifier and a financial data set corresponding thereto. The index data structure stores an index. The index data structure is sourced from the first data structure 504, the second structure 506, and the third data structure 508. Each of the financial data sets functions as a source for the index, which is based on at least two of the financial data sets. Such arrangement can be implemented via a linked list within the database 502, where the index data structure 510 links to the first data structure 504, the second structure 506, and the third data structure 508, such as for data sourcing. Such arrangement can also be implemented via a tree within the database 502, where the first data structure 504, the second structure 506, and the third data structure 508 branch to the index data structure 510, such as for data sourcing. Although the first data structure 504, the second data structure 506 are independent of each other, in other embodiments, a dependency can be possible.

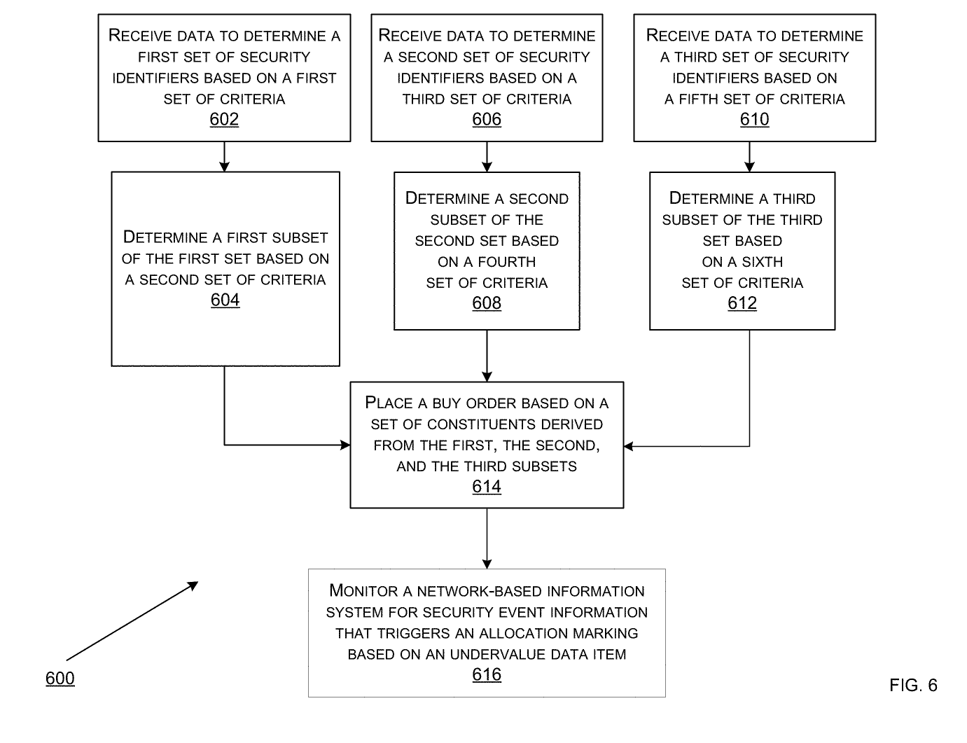

FIG. 6 shows a flowchart of an embodiment of a process of operating a server according to the present disclosure. A process 600 includes a plurality of blocks 602-616. The process 600 can be performed via the topology 100 of FIG. 1. As noted above, the application server 112 comprises a processor comprising a plurality of cores which process in parallel.

In a block 602, the application server 112 receives data to determine a first set of security identifiers based on a first set of criteria, such as a rule set, as disclosed herein. For example, the application server 112 receives data to generate or identify a first set of company identifiers that are associated with companies which bought back shares in last twelve months or another time period. The application server 112 receives such data from a data source, such as the application server 132.

In a block 604, the application server 112 determines a first subset of the first set based on a second set of criteria, such as a rule set, as disclosed herein. For example, the application server 112 determines or identifies a first subset of the first set of company identifiers which are associated with companies which bought back shares in a given range, sorts the first subset based on a highest share buyback to lowest share buyback criteria, and selects a portion of the first subset, such as a top one third, such as thirty three constituents. Note that the application server 112 can performs such operations whether communicably interfacing with the remote data source or without such communicable interfacing.

In a block 606, the application server 112 receives data to determine a second set of security identifiers based on a third set of criteria, such as a rule set, as disclosed herein. For example, the application server 112 receives data to generate or identify a second set of companies identifiers which are associated with companies were spun-off in last seven years or another time period. The application server 112 receives such data from a data source, such as the application server 132.

In a block 608, the application server 112 determines a second subset of the second set based on a fourth set of criteria, such as a rule set, as disclosed herein. For example, the application server 112 sorts the second set based on a spin-off age and a positive net income, determines or identifies the second subset based on a portion of the second subset, such as a top one third, such as thirty three constituents, and selects the portion. Note that the application server 112 can performs such operations whether communicably interfacing with the remote data source or without such communicable interfacing.

In a block 610, the application server 112 receives data to determine a third set of security identifiers based on a fifth set of criteria, such as a rule set, as disclosed herein. For example, the application server 112 receives data on largest holdings of hedge fund managers. The application server 112 receives such data from a data source, such as the application server 132.

In a block 612, the application server 112 determines a third subset of the third set based on a fourth set of criteria, such as a rule set, as disclosed herein. For example, the application server 112 ranks or identifies rankings of a plurality of constituent identifiers based on a hedge fund's holding rank and selects the constituent identifiers based on those rankings. Note that in the blocks 602-612, the first through sixth sets of criteria are received via the GUI of the application running on the OS of the workstation 118, as disclosed herein. Also, note that the blocks 602-612 can be performed in parallel via the cores, as disclosed herein, which can be dedicated.

In a block 614, the application server 112 places a buy order based on a set of constituents derived from the first subset, the second subset, and the third subset. The buy order can be placed over the WAN 102 to an electronic trading platform server, such as NASDAQ. For example, the electronic trading platform server comprises the application server 132. Such derivation is based on a set of rules, as preset in advance. For example, the derivation can be based on a selection of constituents of at least one of the first subset, the second subset, or the third subset based on a price earnings ratio, beta, market cap, weight, volume, earnings per share, dividend, historical pricing, buybacks, splits, undervaluation, or any other information relevant to an owner or a trader of a security associated with that security symbol. The buy order comprises a message generated based on at least one constituent of the set derived from the first subset, the second subset, and the third subset.

In a block 616, the application server 112 monitors a network-based information system for security event information that triggers an allocation marking based on an undervalue data item. The network-based information system can comprise the application server 132. Such monitoring can be over WAN 102. Such monitoring can be pull based or push based, which can be periodic. The allocation marking can be a mark, such as a flag, in a data structure, as disclosed herein. For example, the security event information can be informative of an acquisition, a delisting, bankruptcy, or a spin-off associated with a constituent identifier from the set of constituents of block 614. Note that such monitoring can be performed in parallel by the cores, as disclosed herein.

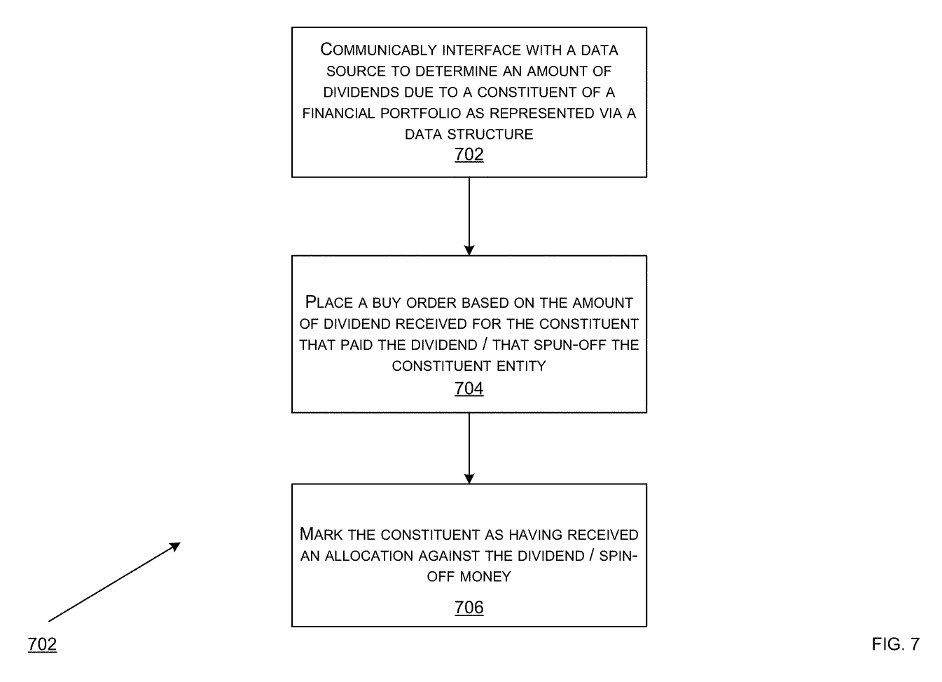

FIG. 7 shows a flowchart of an embodiment of a process of marking a data structure according to the present disclosure. A process 700 includes a plurality of blocks 702-706. The process 700 can be performed via the topology 100 of FIG. 1. As noted above, the application server 112 comprises a processor comprising a plurality of cores which process in parallel.

In a block 702, the application server 112 communicably interfaces with a data source to determine an amount of dividend due to a constituent of a financial portfolio as represented via a data structure, as disclosed herein. For example, the data source comprise the application server 132.

In a block 704, the application server 112 places a buy order based on the amount of dividend received for the constituent that paid the dividend/that spun off the constituent entity. The amount of dividend received is a numerical value corresponding to the amount of dividend received for the constituent that paid the dividend/that spun off the constituent entity. This numerical value is received as data via the application server 112 via interfacing with the data source of the block 702. The buy order can be placed over the WAN 102 to an electronic trading platform server, such as NASDAQ. For example, the electronic trading platform server comprises the application server 132. The buy order comprises a message generated based on the numerical value for the constituent.

In a block 706, the application server 112 marks the constituent as having received an allocation against the dividend/spin-off money. Such marking is via a mark, such as a flag, in a data structure, as disclosed herein. Such marking can be immediate or deferred, such as for after 1 minute, such upon action verification. Note that the blocks 702-706 can occur in parallel, as disclosed herein.

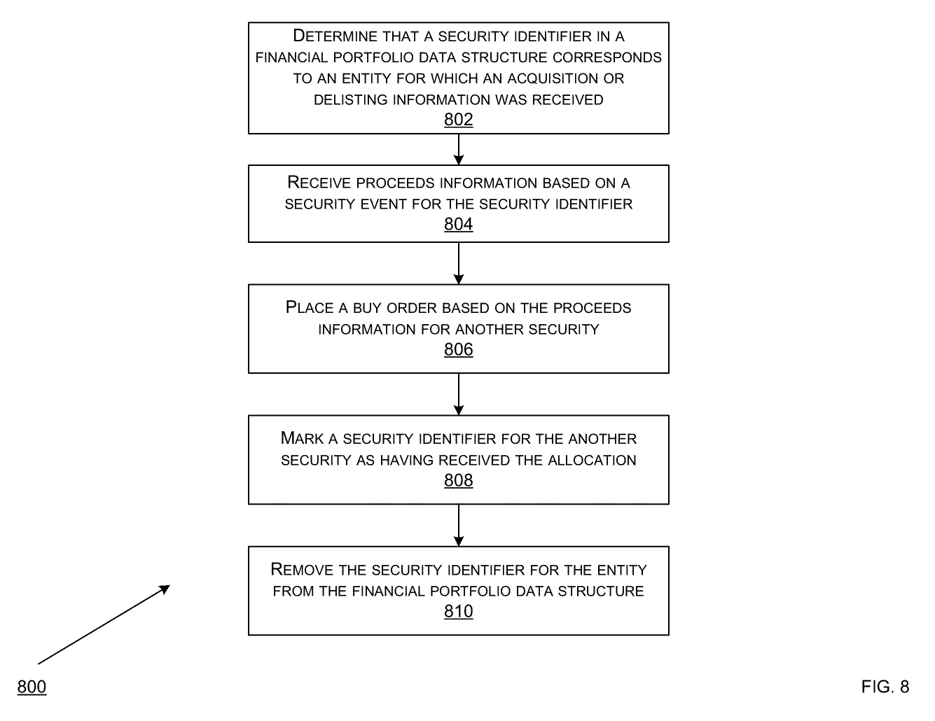

FIG. 8 shows a flowchart of an embodiment of a process of editing a data structure according to the present disclosure. A process 800 includes a plurality of blocks 802-810. The process 800 can be performed via the topology 100 of FIG. 1. As noted above, the application server 112 comprises a processor comprising a plurality of cores which process in parallel.

In a block 802, the application server 112 determines that a security identifier in a financial portfolio data structure corresponds to an entity for which an acquisition or delisting information was received. Such determination can occur via the application server 112 communicably interfacing with a data source, such as the application server 132, and matching the security identifier in the financial portfolio data structure to such information.

In a block 804, the application server 112 receives proceeds information based on a security event. Such receipt can occur via the application server 112 communicably interfacing with a data source, such as the application server 132. The security event corresponds to the acquisition or the delisting. The proceeds information is a numerical amount associated with the security event, such as $1,000.

In a block 806, the application server 112 places a buy order based on the proceeds information for another security. The application server 112 generates the buy order based on the proceeds information and sends the buy order to an electronic trading platform server, such as NASDAQ, over the WAN 102. For example, the electronic trading platform server comprises the application server 132. The buy order comprises a message generated based on the numerical amount.

In a block 808, the application server 112 marks a security identifier for the another security as having received the allocation. The application server 112 accesses the financial portfolio data structure, edits the financial portfolio data structure to indicate that the buy order was placed, and marks the security identifier in the financial portfolio data structure as having received the allocation. For example, the marking can be via a flag.

In a block 810, the application server 112 removes the security identifier for the entity from the financial portfolio data structure. The entity is the entity for which the acquisition or delisting information was received. Such removal can be via deleting the security identifier from the financial portfolio data structure, such as via erasing a record associated with the security identifier in the financial portfolio data structure. Alternatively, such removal can be via keeping the record associated with the financial security identifier in the financial portfolio data structure, but ignoring the security identifier in the financial portfolio data structure from or for subsequent relevant processing. Note that the block 802-810 can occur in parallel, as disclosed herein.

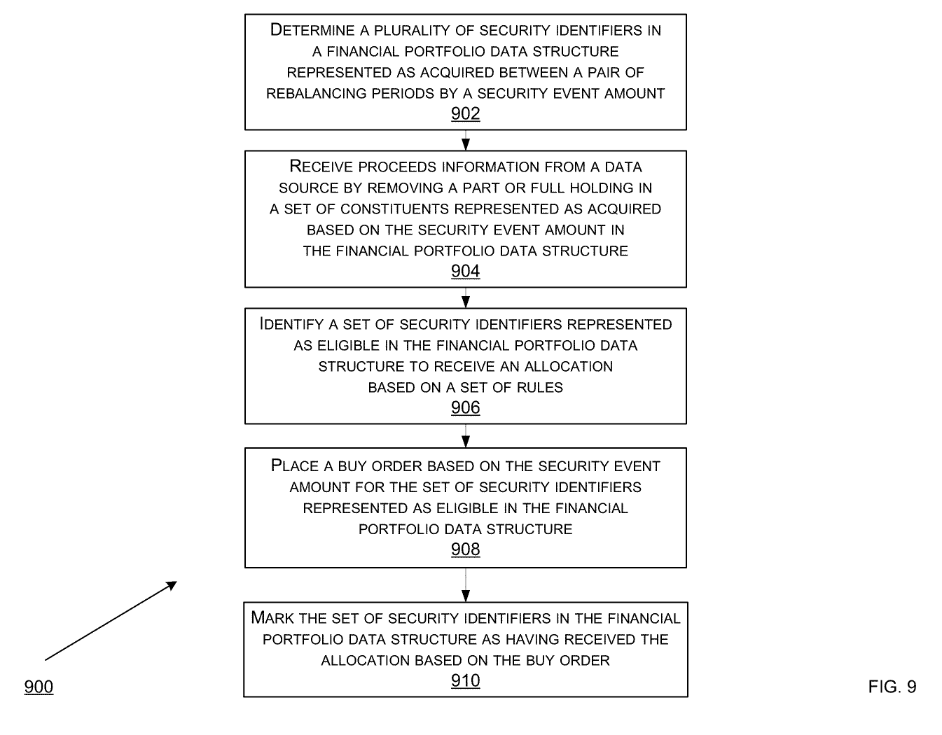

FIG. 9 shows a flowchart of an embodiment of a process of modifying a data structure according to the present disclosure. A process 900 includes a plurality of blocks 902-910. The process 900 can be performed via the topology 100 of FIG. 1. As noted above, the application server 112 comprises a processor comprising a plurality of cores which process in parallel.

In a block 902, the application server 112 determines a plurality of security identifiers in a financial portfolio data structure represented as acquired between a pair of rebalancing periods by a security event amount, as disclosed herein. Such determination can be scanning the financial portfolio data structure based on a set of rules, as disclosed herein.

In a block 904, the application server 112 receives proceeds information from a data source by removing a part or full holding in a set of constituents represented as acquired based on the security event amount in the financial portfolio data structure, as disclosed herein. Such receipt can be via the WAN 102. For example, the data source comprises the application server 132. Such removal can be via modifying or editing the financial portfolio data structure, such as via writing or deleting records. Alternatively, such removal can be via keeping, yet ignoring, such records.

In a block 906, the application server 112 identifies a set of security identifiers represented as eligible in the financial data structure to receive an allocation based on a set of rules, as disclosed herein. Such identification occurs via the application server 112 scanning the financial portfolio data structure based on a set of rules, as disclosed herein.

In a block 908, the application server 112 places a buy order based on the security event amount for the set of security identifiers represented as eligible in the financial portfolio data structure. The application server 112 generates the buy order based on the security event amount and sends the buy order to an electronic trading platform server, such as NASDAQ, over the WAN 102. For example, the electronic trading platform server comprises the application server 132. The buy order comprises a message generated based on the security event amount.

In a block 910, the application server 112 marks the set of security identifiers in the financial portfolio data structure as having received the allocation based on the buy order. Such marking is via a mark, such as a flag, in the financial portfolio data structure, as disclosed herein. Such marking can be immediate or deferred, such as for after 1 minute, such upon action verification. Note that the blocks 902-910 can occur in parallel, as disclosed herein.

In some embodiments, a plurality of rules or rule sets, as input by a user via the GUI of the application running on the OS of the workstation 118, can be received by the application server 112, which can communicably interface with the application server 134, to implement an algorithm described herein. For example, the algorithm enables a creation of an ETF data structure which enables a seeking of investment results that can correspond generally to a performance of an index, such a financial portfolio, as disclosed herein. For simplicity, this example assumes that this index has an inception date of Feb. 1, 2016. For example, note that assuming the birth date of February or March 2016 (i.e., in the first quarter of 2016), the index will use the constituents that are generated by a portfolio that was launched (as a back-tested portfolio) 27 quarters (Gestation period) prior to the birth date. This back-tested portfolio concept is detailed below. Assuming an ETF inception date in the second quarter of 2016, the ETF data structure will start tracking the index during the 28th quarter of that same back-tested portfolio.

As represented in memory, this index is composed of 3 data sets: Cannibal, Spin-Off and Cloning, each of which has been described below. These are 3 independent data sets and the corporate event money values from each data set is reinvested back into its own respective data set. If a company is part of more than one data set, such as Cannibal and Cloning, then the index invests money values in that company from both data sets. The maximum allocation in that company, however, can be 3.5% of its total market capitalization. If a company is part of more than one data set and the 3.5% market cap limit is reached, then the investment can be brought down to 3.5% first from Cannibal and then, from Spin-Off & Cloning equally.

For example, as per this algorithm, the index can invest $20 million in a hypothetical company “ABC” from Cloning data set and another $30 million from Spin-Off data set. The market cap of company ABC is $1 billion. The index can invest only up to $35 million. Ideally, the total investment from both data sets should be $50 million (i.e., there will be an excess of $15 million). To reduce the investment to 3.5% of the market cap, the index invests $7.5 million less from each of the 2 data sets, thus, investing only $12.5 million from Cloning and $22.5 million from Spin-Off. The constituents bought on the birth date are the constituents at the beginning of the Gestation period, 27th quarter, of a back-tested portfolio that was launched 27 quarters back and run, as per the rules disclosed herein. For simplicity, the birth date is assumed to be Feb. 1, 2016 (in Q1 2016) and the “conception date” is 27 quarters prior to birth date, or Jul. 1, 2009. At the conception date (i.e., Jul. 1, 2009) each component is equally-weighted within their respective data sets. However, on the birth date (Feb. 1, 2016), the weight of each constituent in the 3 data sets is the amount held in that constituent as a percentage of total portfolio value at the beginning of the 27th quarter of the back-tested performance. The initial investment amount can be $1 billion on the conception date (i.e., Jul. 1, 2009), as well as on the birth date of 27th Quarter (i.e., Feb. 1, 2016). The allocation among Buckets can be on the conception date (i.e., Jul. 1, 2009): Cannibal: 75% of Initial assets under management (AUM), Cloning: 20% of Initial AUM, Spin-Off: 5% of Initial AUM. The allocation at the birth date (i.e., Feb. 1, 2016) will be as per the 27th Quarter results of the portfolio whose conception date is 27 quarters (i.e., Jul. 1, 2009) before the birth date. The diversification requirements can be from the first 50% of the total portfolio value, the index's investment in a single stock cannot be more than 17% of the total portfolio value on the first trading day of the quarter (the “rebalancing date”). The algorithm ensures that (i) the maximum allocation in any one company does not exceed 3.5% of the total market capitalization of that company, and (ii) the allocation in a single company does not exceed 17% of the total portfolio value. However, note that such configurations are illustrative and the maximum allocation and/or the allocation in the single company can be selectively adjusted in any manner, whether up or down for any purpose. The representative position held in these companies is allowed to temporarily increase up to (i) 4% of the total market capitalization of the company, and (ii) 20% of the total portfolio value, respectively. However, again note that such configurations are illustrative and the representative position can be selectively adjusted in any manner, whether up or down for any purpose. The birth date can be 27th Quarter from the conception date (e.g.: if conception date is Jul. 1, 2009, then the birth date will be in Q1 2016). The rebalancing date can be when the index evaluates the portfolio constituents on 1st trading day of the quarter and sells only the ones that are not selected by the algorithm as constituents in the quarter. From the sale proceeds and event money, the index buys only the new constituents in the next quarter's portfolio as per the rules defined in each of the data sets. The portfolio is rebalanced on the 1st trading day of the quarter. The geography can be U.S. equities and ADRs trading on NYSE, NYSE, ARCA, and NASDAQ exchanges.

The Bucket 1, Cannibal, is based on a data source, such as Compustat tables from Xpressfeed (provided by Capital IQ). The description of Bucket 1 is that on the birth date, there are a particular number of companies—n, let's say, n is 33 companies, in the Cannibal portfolio. The portfolio is composed of companies that have bought back their shares in last 12 months. The geography is U.S. equities and ADRs trading on NYSE, NYSE, ARCA, and NASDAQ exchanges. The market cap minimum is $1 billion, but market cap minimum will vary for previous period (refer to Appendix I for the market capitalization information for different periods). The security universe is companies that have bought back between 1% and 26% of their shares in the trailing twelve month period; excluding any reverse stock splits. For example, the birth date can be Feb. 1, 2016 and the latest available data would be on Oct. 31, 2015. So, compare the shares outstanding of a company on Oct. 31, 2015 to the shares outstanding on Oct. 31, 2014. Hypothetically, company ABC had 100 million shares on Oct. 31, 2015 and 120 million shares on Oct. 31, 2014. This implies, the company had a share reduction of 20 million, that is 16.67% share buy-back. This company is eligible to be part of the Cannibal Universe as its share buy-back is in the range of 1%-26%. In order to choose portfolio constituents, sort all the companies in the security universe from largest share buy-back percentage (ensuring reverse splits are excluded) to the smallest buy-back percentage and pick the first n companies (33 companies in this case) from this list. The weighting is equally-weighted on conception date (i.e., Jul. 1 2009). On the birth date (i.e., Feb. 1 2016), it will be weighted as per the percentage holding of the total portfolio value. The maximum ownership as a percentage of a stock's market capitalization is 3.5%. Other restrictions can include no investments in companies that are headquartered in the following countries: Argentina, Brazil, Russia, Colombia, Venezuela, Zimbabwe. No investments in companies that are in the following industries (Industry Level 3 as per GICS): Utilities, Consumer Finance, Airlines, Oil, gas and Consumable fuels, REITs. The rebalancing rule can be that the minimum holding period is 12 months. The removal can be after 12 months in the portfolio, a company is eligible for removal if its share count increases (i.e., if the change in shares outstanding is >0%) in the last 12 months (“trailing 12 month”). If the company has been in the portfolio for 36 months, then it is not removed if it has experienced at least a 2% share count reduction in the previous 12 months OR at least a 0.3% share count reduction in the previous quarter. From the sale proceeds of companies that do not appear in the portfolio in the next quarter as per the rules defined above, the index allocates the event money as per the rules defined herein. The index will buy new companies to ensure that the Cannibal total stays at n companies (33 in this case). The additions can be via the algorithm choosing the new companies to be added to the Cannibal data set with the same rules as at the birth date. It creates a universe of companies that bought back its shares in trailing twelve months in the range of 1% to 26% on rebalance date. This universe of companies is sorted from largest to smallest share buy-back percentage. The index selects a sufficient number of companies from this list so that the portfolio holds n companies (33 in this case) at each rebalance date.

The event money allocation can be enabled via the event money that the index receives as dividend, as proceeds from the sale of spin-offs, delisted companies, bankrupt companies and the acquisitions of index constituents is invested in following ways: (1) dividend money is invested back in the security that pays the dividend, where the shares bought with the dividend amount are sold at the end of the quarter and that amount is added to the event money, (2) proceeds from the sale of spin-offs of portfolio constituents is invested back in the constituent that spun-off the entity, where the shares bought with the spin-off amount are sold at the end of the quarter and that amount is added to the event money, (3) other corporate events' money (from Acquisition, Delisting, Bankruptcy, etc.) is invested in Berkshire Class B shares.

At the end of the quarter, all the shares bought from event, spin-off and dividend money received during the quarter are sold and the amount is treated as event money. Also, any sale proceeds received from selling the companies as per the “Removal rules” above are added to the Cannibal event money. The Cannibal event money is then allocated to the new portfolio at the next rebalance date. The Cannibal event money allocation is to 3 different categories: (a) companies that are more than 3 years old in the Cannibal portfolio, (b) companies that are 2 years to 3 years old in the Cannibal portfolio, or (c) new companies that enter the Cannibal portfolio at the rebalance date. If there are companies in all 3 categories (a, b and c), then the index allocates 35% of the event money to category a), that is, more than 3 years old companies. The next 35% of the event money is allocated to category b), that is, 2 years to 3 years old companies in the portfolio and the balance 30% of the event money goes to the new companies that are bought at the rebalance date to bring the number of companies to n companies (33 in this case) (if companies are removed due to delisting, acquisition or bankruptcy, and any of the above mentioned “Removal rules”). The algorithm accounts for all combinations that are possible for event money allocation. If there are no companies in the portfolio from category (a), then 70% of the event money goes to category, (b) and 30% goes to category (c). If there are no companies in either category a) or category b), then 100% of the event money goes to category (c). Similarly, if there are companies in category (a) but no companies in category (b), then category (c) gets the 35% from there and hence, has 65% of total event money. If there are no companies in either of the categories, then the index divides the Cannibal event money equally amongst the existing Cannibal portfolio.

The various cases and the corresponding event money allocation has been defined as: 1 is when there are companies in that category and 0 is when there are no companies in that category.

| | Example | | Example | | Example | | Example | | Example | | Example | | Example | | Example | |
|---|---|---|---|---|---|---|---|---|---|---|---|---|---|---|---|---|
| | Case 1 | | Case 2 | | Case 3 | | Case 4 | | Case 5 | | Case 6 | | Case 7 | | Case 8 | |
| a) >3 | 1 | 35% | 0 | | 1 | 35% | 1 | 50% | 0 | | 0 | | 1 | 100% | 0 | 100% |
| years | | | | | | | | | | | | | | | | equally |
| old | | | | | | | | | | | | | | | | in |
| b) 2-3 | 1 | 35% | 1 | 70% | 0 | | 1 | 50% | 0 | | 1 | 100% | 0 | | 0 | existing |
| years | | | | | | | | | | | | | | | | portfolio |
| old | | | | | | | | | | | | | | | | |
| c) New | 1 | 30% | 1 | 30% | 1 | 65% | 0 | | 1 | 100% | 0 | | 0 | | 0 | |
| Entrants | | | | | | | | | | | | | | | | |

With respect to the holding constraints, if the index's holding of a company reaches 4% of the company's total market capitalization, then the index sells the excess shares to reduce the position in that company to 3.5% of its market capitalization. The index adds the sale proceeds to the event money.

With respect to Bucket 2: the Spin-Off Bucket, the data source is Compustat tables from Xpressfeed (provided by Capital IQ). At the birth date, there are 25 to 33 companies in the Spin-Off portfolio This range of the number of companies in the portfolio may vary. The portfolio is composed of companies that were spun-off at least 1 year and at most 7 years prior to the conception date/rebalance date. The 7-year limit is flexible. With respect to geography, U.S. equities and ADRs trading on NYSE, NYSE, ARCA, and NASDAQ exchanges can be used. The market cap minimum is $500 million. This Bucket employs the universe of companies that were spun-off 1 year to 7 years prior to the conception date/rebalance date. In order to choose the portfolio constituents, from the universe, the index excludes the companies with negative earnings (net income) in trailing twelve months on conception date/rebalance date. It then sorts the filtered universe from most recent spin-off date to the oldest spin-off date and selects at least 25 and at most 33 companies from this list.

For example, for the birth date of Feb. 1, 2016, period for considering the spin-off: Jan. 1, 2009-Dec. 31, 2014, there are 5 spin-offs:

| | | Net Income in Trailing twelve |
|---|---|---|
| Company | Spin-Off Date | month |
| A | Feb. 10, 2014 | $300 million |
| B | Aug. 18, 2012 | $(100) million |
| C | Oct. 28, 2015 | NA |
| D | Nov. 12, 2008 | $50 million |
| E | Jun. 9, 2010 | $400 million |

In this case, Company C won't be part of the universe as it was spun-off within 12 months prior to the rebalance date. Company A, Company B and Company E will be the only companies that will be part of the universe. Company D is more than 7 years older on Feb. 1, 2016. Out of the 3 companies in the universe, only Company A and Company E are the part of the index's portfolio. Company B has made loss in trailing 12 months and hence, the index does not select it part of for the Spin-Off data set at this rebalance date. Regarding weighting, equally-weighted on conception date (i.e., Jul. 1, 2009), but on the birth date (i.e., Feb. 1, 2016), this will be weighted as per the percentage holding of the total portfolio value. The maximum ownership as a % of a stock's market capitalization is 3.5%. Other Restrictions include no investments in companies that are headquartered in the following countries: Argentina, Brazil, Russia, Colombia, Venezuela, and Zimbabwe. There is no investment in companies that are in the following industries (Industry Level 3 as per GICS): Utilities, Consumer Finance, Airlines, Oil, gas and Consumable fuels, REITs.

The rebalancing rule includes removals where during every quarter the index removes 3 companies in the following priority order: (1) Involuntary removal—Acquisition, Delisting, Bankruptcy, (2) Negative Net Income in trailing 12 months (if in portfolio for more than 12 months), and (3) Companies whose spin-off date is more than 7 years old from the rebalancing date. In the above cases, the index removes 3 companies only. If in case, there are more than 3 companies in case 1, then the index adds a sufficient number of companies to reach at least 25 constituents and at most 33 constituents again. If there are less than 3 companies in Case 1, then the index removes the balance companies (to make it 3 removals) from Case 2 and then, from case 3. If there are more than the required companies eligible for removal in case 2, then the index selects the oldest companies with trailing 12-month NI<0. From the sale proceeds of sale of companies that do not appear in the portfolio for the next quarter as per the “Removal rules” defined above, the index allocates the event money as per the rules disclosed herein. At every rebalance date, the index buys new companies to ensure that the Spin-Off total is always between 25 to 33 companies. In terms of additions, the index adds the companies in the portfolio using the same rules on birth date. It selects the companies by age, starting with companies as old as 12 months with trailing 12 month net income greater than 0. It, then, moves back quarter-by-quarter (date-by-date, within a quarter) till one of the 2 conditions are met: the index reaches at most 33 constituents in Spin-Off data set, OR the index covers companies as old as 7 years with positive earnings in trailing twelve-months.

Regarding event money allocation, the event money that the index receives as dividend, as proceeds from the sale of spin-offs, delisted companies, bankrupt companies and the acquisitions of index constituents is invested in following ways: (1) dividend money is invested back in the security that pays the dividend, where the shares bought with the dividend amount are sold at the end of the quarter and that amount is added to the event money, (2) proceeds from the sale of Spin-Offs of portfolio constituents is invested back in the constituent that spun-off the entity, where the shares bought with the spin-off amount are sold at the end of the quarter and that amount is added to the event money, (3) other corporate events' money (from Acquisition, Delisting, Bankruptcy, etc.) is invested in Berkshire Class B shares. At the end of the quarter, all the shares bought from event, spin-off and dividend money received during the quarter are sold and the amount is treated as event money. Also, any sale proceeds received from selling the companies as per the “Removal rules” above are added to the Spin-Off event money. The index allocates the Spin-Off event money to the new portfolio at the next rebalancing date. The index invests 50% of the Spin-Off event money equally amongst the existing portfolio and the remaining 50% is invested equally amongst the new constituents. Regarding the holding constraints, if the index's holding of a company reaches 4% of the company's total market capitalization, then the index sells the excess shares to reduce the position in that company to 3.5% of its market capitalization. The index adds the sale proceeds to the event money.

With respect to Bucket 3, the Cloning Bucket, the data source sources 13-F forms filed with SEC every quarter for the holdings of hedge funds. The companies' shares outstanding and prices are sourced from Compustat tables in Xpressfeed (provided by Capital IQ). At the birth date, there are 34 companies in the Cloning portfolio. The portfolio is composed of companies that are top holdings of a list of value hedge-funds (APPENDIX II). U.S. equities and ADRs trading on NYSE, NYSE, ARCA, and NASDAQ exchanges can be used. The market cap minimum is $1 billion. In terms of the security universe, companies that are the holdings of 22 hedge fund-managers (24 Fund managers for back-test purpose) (APPENDIX II) one quarter prior to the conception date/rebalance date. The index considers the position of the hedge fund in common stocks only, thus excluding any position in call or put options, REITs, Preferred Shares, warrants. Also, the index consolidates the hedge fund's position in all share classes for a given company. In order to choose the portfolio constituents, the index sorts the companies in the security universe by their hedge-fund managers and by the fund manager's largest position to the smallest position in a company. The index then selects companies in a particular hedge-fund sequence. Each of these hedge-funds have pre-set limits for the number of companies that will become part of the portfolio.

For example, for the birth date of Feb. 1, 2016, the latest available 13-F forms for all hedge funds will be for Quarter 3, 2015. All the holdings of each hedge fund in Q3 2015 are sorted from largest to smallest holding in each company. The first hedge fund in the cloning list is ValueAct and the pre-set limit for ValueAct is 2 companies. Then, the index picks the top 2 companies by holding in ValueAct's portfolio and those companies become part of the index's portfolio as well. Then, the index moves to the next hedge fund. There are 22 such hedge funds for index (24 Fund managers for back-test purpose) provided in Appendix II. The index iterates through 22 Hedge funds' Top holdings, selects the Top n holdings (as per pre-set limit provided in Appendix II) for each hedge fund manager, and then moves to the next manager till there are 34 companies in the portfolio. The hedge fund managers have a certain priority order given in the Appendix II. During each iteration, if the index encounters a company that is already included in the portfolio from a previous hedge-fund manager, then it selects the company at the next position in that hedge fund. Similarly, if a company's market capitalization is less than $1 billion, then, the index selects the company at the next position in that hedge fund. In terms of weighting, the index is equally-weighted on conception date (i.e., Jul. 1, 2009). On birth date (i.e., Feb. 1, 2016), the index is weighted as per the percentage holding of the total portfolio value. The maximum ownership as a % of a stock's market capitalization is 3.5% and there is no minimum holding period. Regarding removals, the index removes only the companies that have been sold-off by the hedge fund manager through which it had become a portfolio constituent OR if its rank has dropped by more than 5 in the fund manager's portfolio.

For example, Valeant Pharmaceuticals was the largest holding in SQ Advisors' (hedge-fund) portfolio in Quarter 3, 2015. This becomes part of the portfolio from SQ Advisors. Now, while rebalancing on Apr. 1, 2016, Valeant's position in SQ Advisor has moved down to Rank 4 (referring to Quarter 4, 201513-F). The index continues to hold it in the portfolio in Quarter 2, 2016. However, while rebalancing on Jul. 1, 2016, if Valeant's position is 7th largest holding in SQ Advisor's portfolio (referring to Quarter 1, 2016 13-F). At this point, the index will remove Valeant from the portfolio as its rank has dropped by 6 places (Rank 7-Rank 1) in SQ Advisor itself. Had SQ Advisors unwind their position in Valeant in that quarter, the index would have removed it from the portfolio as well.

Regarding additions, the index selects the new companies for Cloning data set following the same rules as at the birth date. The algorithm iterates through the holdings in each hedge fund. The algorithm checks the hedge funds' whose pre-set limits have not reached yet and selects a sufficient number of companies from the Universe to have 34 constituents at each rebalance date.

Regarding event money allocation, the event money that the index receives as dividend, as proceeds from the sale of spin-offs, delisted companies, bankrupt companies and the acquisitions of index constituents is invested in following ways: (1) dividend money is invested back in the security that pays the dividend, with the shares bought with the dividend amount are sold at the end of the quarter and that amount is added to the event money, (2) proceeds from the sale of Spin-Offs of portfolio constituents is invested back in the constituent that spun-off the entity, with the shares bought with the spin-off amount are sold at the end of the quarter and that amount is added to the event money, (3) other corporate events' money (from Acquisition, Delisting, Bankruptcy, etc.) is invested in Berkshire Class B shares. At the end of the quarter, all the shares bought from event, spin-off and dividend money received during the quarter are sold and the amount is treated as event money. Also, any sale proceeds received from selling the companies as per the “Removal rules” above are added to the Cloning event money. The index invests 100% of the Cloning wallet amount equally amongst the new entrants in the Cloning data set. If there are no new additions in a quarter in Cloning data set, then the index allocates 100% of the Cloning event money equally amongst the existing companies in the Cloning data set. In terms of holding constraints, if the index's holding of a company reaches 4% of the company's total market capitalization, then the index sells the excess shares to reduce the position in that company to 3.5% of its market capitalization. The index adds the sale proceeds to the event money.

### APPENDIX I—Market Caps for Back-Test Purpose

### Cannibal:

1999-2000—$250 million
2001-2010—$500 million
2011-Present—$1 billion

### Cloning:

1999-2000—$250 million
2001-2010—$500 million
2011-Present—$1 billion

### Spin-Off:

1991-2000—$25 million
2001-2005—$100 million
2006-Present—$500 million

### APPENDIX II

List of Hedge Funds Along with Companies to be Cloned (Pre-Set Limit) in Each Iteration from Each Fund in the Given Priority Order

### Specific Restriction:

Universe of securities to be cloned from Berkshire Hathaway are the ones whose market cap is under $50 billion
FOR BACKTESTING FROM 2005 Q1—Universe of securities to be cloned from Berkshire Hathaway are limited to the new additions in the portfolio of Berkshire Hathaway since 2004 Q3
Third Avenue Management and Southeastern Asset Management are considered to be part of the index's portfolio only till 2006 Q3 (included)

| Priority | | Pre-Set |
|---|---|---|
| Order | Hedge Fund | Limit |
| 1 | ValueAct Capital | 2 |
| 2 | Berkshire Hathaway Inc. | 3 |
| 3 | Arlington Value Capital, LLC | 2 |
| 4 | Greenlight Capital | 2 |
| 5 | Appaloosa Management | 2 |
| 6 | FPA Capital Fund, Inc. | 2 |
| 7 | SQ Advisors, LLC | 2 |
| 8 | Invesco Private Capital | 2 |
| 9 | Dalal Street LLC/Pabrai Investment Funds | 2 |
| 10 | Sequoia Fund, Inc. | 2 |
| 11 | Pershing Square Holdings Ltd. | 2 |
| 12 | Third Point LLC | 2 |
| 13 | Fairholme Capital Management, LLC | 1 |
| 14 | Icahn Capital Management LP | 2 |
| 15 | Markel Insurance | 1 |
| 16 | Blue Ridge Capital, LLC | 2 |
| 17 | Tweedy, Browne Company LLC | 1 |
| 18 | Leucadia National Corp. | 1 |
| 19 | Baupost Group LLC | 1 |
| 20 | Abrams Capital Management LP | 1 |
| 21 | Lone Pine Capital LLC | 1 |
| 22 | Maverick Capital, Ltd. | 1 |
| 23 | Third Avenue Management (on or before 2006 Q3 | 3 |
| | only) | |
| 24 | Southeastern Asset Management (on or before 2006 | 3 |
| | Q3 only) | |

Various embodiments of the present disclosure may be implemented in a data processing system suitable for storing and/or executing program code that includes at least one processor coupled directly or indirectly to memory elements through a system bus. The memory elements include, for instance, local memory employed during actual execution of the program code, bulk storage, and cache memory which provide temporary storage of at least some program code in order to reduce the number of times code must be retrieved from bulk storage during execution.

Input/output or I/O devices (including, but not limited to, keyboards, displays, pointing devices, DASD, tape, CDs, DVDs, thumb drives and other memory media, etc.) can be coupled to the system either directly or through intervening I/O controllers. Network adapters may also be coupled to the system to enable the data processing system to become coupled to other data processing systems or remote printers or storage devices through intervening private or public networks. Modems, cable modems, and Ethernet cards are just a few of the available types of network adapters.

The present disclosure may be embodied in a system, a method, and/or a computer program product. The computer program product may include a computer readable storage medium (or media) having computer readable program instructions thereon for causing a processor to carry out aspects of the present disclosure. The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language, R programming language or similar programming languages. A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, among others. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions. The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Words such as “then,” “next,” etc. are not intended to limit the order of the steps; these words are simply used to guide the reader through the description of the methods. Although process flow diagrams may describe the operations as a sequential process, many of the operations can be performed in parallel or concurrently. In addition, the order of the operations may be re-arranged. A process may correspond to a method, a function, a procedure, a subroutine, a subprogram, etc. When a process corresponds to a function, its termination may correspond to a return of the function to the calling function or the main function.

Although preferred embodiments have been depicted and described in detail herein, it will be apparent to those skilled in the relevant art that various modifications, additions, substitutions and the like can be made without departing from the spirit of the disclosure, and these are, therefore, considered to be within the scope of the disclosure, as defined in the following claims.

Features or functionality described with respect to certain example embodiments may be combined and sub-combined in and/or with various other example embodiments. Also, different aspects and/or elements of example embodiments, as disclosed herein, may be combined and sub-combined in a similar manner as well. Further, some example embodiments, whether individually and/or collectively, may be components of a larger system, wherein other procedures may take precedence over and/or otherwise modify their application. Additionally, a number of steps may be required before, after, and/or concurrently with example embodiments, as disclosed herein. Note that any and/or all methods and/or processes, at least as disclosed herein, can be at least partially performed via at least one entity or actor in any manner.

The terminology used herein can imply direct or indirect, full or partial, temporary or permanent, action or inaction. For example, when an element is referred to as being “on,” “connected” or “coupled” to another element, then the element can be directly on, connected or coupled to the other element and/or intervening elements can be present, including indirect and/or direct variants. In contrast, when an element is referred to as being “directly connected” or “directly coupled” to another element, there are no intervening elements present.

Although the terms first, second, etc. can be used herein to describe various elements, components, regions, layers and/or sections, these elements, components, regions, layers and/or sections should not necessarily be limited by such terms. These terms are used to distinguish one element, component, region, layer or section from another element, component, region, layer or section. Thus, a first element, component, region, layer, or section discussed below could be termed a second element, component, region, layer, or section without departing from the teachings of the present disclosure.

Furthermore, relative terms such as “below,” “lower,” “above,” and “upper” can be used herein to describe one element's relationship to another element as illustrated in the accompanying drawings. Such relative terms are intended to encompass different orientations of illustrated technologies in addition to the orientation depicted in the accompanying drawings. For example, if a device in the accompanying drawings were turned over, then the elements described as being on the “lower” side of other elements would then be oriented on “upper” sides of the other elements. Similarly, if the device in one of the figures were turned over, elements described as “below” or “beneath” other elements would then be oriented “above” the other elements. Therefore, the example terms “below” and “lower” can encompass both an orientation of above and below.

The terminology used herein is for describing particular example embodiments and is not intended to be necessarily limiting of the present disclosure. As used herein, the singular forms “a,” “an” and “the” are intended to include the plural forms as well, unless the context clearly indicates otherwise. The terms “comprises,” “includes” and/or “comprising,” “including” when used in this specification, specify the presence of stated features, integers, steps, operations, elements, and/or components, but do not preclude the presence and/or addition of one or more other features, integers, steps, operations, elements, components, and/or groups thereof.

As used herein, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances.

Unless otherwise defined, all terms (including technical and scientific terms) used herein have the same meaning as commonly understood by one of ordinary skill in the art to which this disclosure belongs. The terms, such as those defined in commonly used dictionaries, should be interpreted as having a meaning that is consistent with their meaning in the context of the relevant art and should not be interpreted in an idealized and/or overly formal sense unless expressly so defined herein.

As used herein, the term “about” and/or “substantially” refers to a +/−10% variation from the nominal value/term. Such variation is always included in any given.

If any disclosures are incorporated herein by reference and such disclosures conflict in part and/or in whole with the present disclosure, then to the extent of conflict, and/or broader disclosure, and/or broader definition of terms, the present disclosure controls. If such disclosures conflict in part and/or in whole with one another, then to the extent of conflict, the later-dated disclosure controls.

1. A method comprising:
presenting, by a server, over a local area network, a first graphical user interface in a first application running on a first operating system of a first client, wherein the server comprises a processor comprising a plurality of cores that process in parallel, wherein the first graphical user interface is programmed to receive a plurality of a financial data set identifiers and a plurality of rule sets, wherein the first graphical user interface comprises a control graphical element programmed to trigger a submission of the financial data set identifiers and the rule sets from the client to the server over the local area network, wherein the financial data set identifiers correspond to the rule sets in a one-to-one manner;
in response to the submission based on an activation of the control graphical element, populating, by the server, a first data structure with the financial data set identifiers and a second data structure with the rule sets;
querying, by the server, over a wide area network, based on the populating, a data source based on accessing, by the server, the rule sets in the second data structure;
retrieving, by the server, over the wide area network, a plurality of financial data sets from the data source such that the cores receive the financial data sets in parallel in a one-to-one manner;
formatting, by the server, based on the retrieving, the financial data sets via the cores in parallel in a one-to-one manner such that the financial data sets are formatted for input into the first data structure;
populating, by the server, based on the formatting, the first data structure with the financial data sets based on the retrieving such that the financial data set identifiers correspond to the financial data sets in a one-to-one manner and such that the cores input the financial data sets in parallel into the first data structure in a one-to-one manner without locking the first data structure;
defining, by the server, an index in the first data structure based on the populating the first data structure with the financial data sets, wherein the index is based on the financial data sets, wherein each of the financial data sets comprises a plurality of security identifiers, a plurality of security amounts, and a plurality of security prices, wherein the security identifiers correspond to the security amounts in a one-to-one manner, wherein the security identifiers correspond to the security prices in a one-to-one manner, wherein the financial data sets and the index are embodied via a linked list within the first data structure, wherein the index links to the financial data sets; and
in response to receiving, by the server, over the wide area network, after the defining, a plurality of event messages from the data source, interpreting, by the server, the event messages, accessing, by the server, the rule sets in the second data structure, modifying, by the server, the financial data sets in the first data structure based on the rule sets in the second data structure and the event messages as interpreted such that the cores amend the financial data sets in parallel in the first data structure in a one-to-one manner without locking the first data structure and such that the index is updated accordingly, and granting, by the server, over the wide area network, a read access for the index to a second graphical user interface generated by a second application running on a second operating system of a second client, wherein the read access is during the modifying and after the modifying, wherein the financial data sets are related to the event messages via the security identifiers.

2. The method of claim 1, further comprising:
generating, by the server, a report based on the financial data set identifiers and the financial data sets in the first data structure after the populating the first data structure with the financial data sets;
presenting, by the server, the report to at least one of the first client over the local area network or the second client over the wide area network;
updating, by the server, the report dynamically on at least one of the first client over the local area network or the second client over the wide area network based on the modifying during the presenting.

3. The method of claim 1, wherein the financial data sets do not have a security identifier in common during at least one of the defining or the modifying.

4. The method of claim 1, wherein the cores are dedicated to processing the financial data sets in a one-to-one manner during at least one of the retrieving, the populating the first data structure with the financial data sets, or the modifying.

5. The method of claim 1, wherein the modifying comprises replacing an original member of at least one of the financial data sets with a new member.

6. The method of claim 1, wherein the read access is a first read access, and further comprising:
in response to the defining, generating, by the server, a third data structure comprising the financial data set identifiers and the financial data sets obtained from the first data structure, wherein the financial data set identifiers in the third data structure correspond to the financial data sets in a one-to-one manner;
modifying, by the server, based on the generating, at least one of the financial data sets in the third data structure based on a change in at least one of the financial data sets, the first data structure based on the rule sets in the second data structure, and the event messages as interpreted;
granting, by the server, over the wide area network, a second read access to the second client, wherein the second read access is for the third data structure.

7. The method of claim 1, wherein the data sources pushes the event messages onto the server.

8. The method of claim 1, wherein the server pulls the event messages from the data source.

9. (canceled)

10. The method of claim 1, wherein the financial data sets and the index are embodied via a tree within the first data structure, wherein the financial data sets branch to the index.

11. A system comprising:
a server comprising a processor comprising a plurality of cores which process in parallel, wherein the server is configured to:
present, over a local area network, a first graphical user interface in a first application running on a first operating system of a first client, wherein the first graphical user interface is programmed to receive a plurality of a financial data set identifiers and a plurality of rule sets, wherein the first graphical user interface comprises a control graphical element programmed to trigger a submission of the financial data set identifiers and the rule sets from the client to the server over the local area network, wherein the financial data set identifiers correspond to the rule sets in a one-to-one manner;
in response to the submission based on an activation of the control graphical element, populate a first data structure with the financial data set identifiers and a second data structure with the rule sets;
query, over a wide area network, based on the populating, a data source based on accessing, by the server, the rule sets in the second data structure;
retrieve, over the wide area network, a plurality of financial data sets from the data source such that the cores receive the financial data sets in parallel in a one-to-one manner;
format, based on the retrieving, the financial data sets via the cores in parallel in a one-to-one manner such that the financial data sets are formatted for input into the first data structure;
populate, based on the formatting, the first data structure with the financial data sets based on the retrieving such that the financial data set identifiers correspond to the financial data sets in a one-to-one manner and such that the cores input the financial data sets in parallel into the first data structure in a one-to-one manner without locking the first data structure;
define an index in the first data structure based on the populating the first data structure with the financial data sets, wherein the index is based on the financial data sets, wherein each of the financial data sets comprises a plurality of security identifiers, a plurality of security amounts, and a plurality of security prices, wherein the security identifiers correspond to the security amounts in a one-to-one manner, wherein the security identifiers correspond to the security prices in a one-to-one manner, wherein the financial data sets and the index are embodied via a linked list within the first data structure, wherein the index links to the financial data sets; and
in response to receiving, by the server, over the wide area network, after the defining, a plurality of event messages from the data source, interpret the event messages, access the rule sets in the second data structure, modify the financial data sets in the first data structure based on the rule sets in the second data structure and the event messages as interpreted such that the cores amend the financial data sets in parallel in the first data structure in a one-to-one manner without locking the first data structure and such that the index is updated accordingly, and grant, over the wide area network, a read access for the index to a second graphical user interface generated by a second application running on a second operating system of a second client, wherein the read access is during the modifying and after the modifying, wherein the financial data sets are related to the event messages via the security identifiers.

12. The system of claim 11, wherein the server is configured to:
generate a report based on the financial data set identifiers and the financial data sets in the first data structure after the populating the first data structure with the financial data sets;
present the report to at least one of the first client over the local area network or the second client over the wide area network;
update the report dynamically on at least one of the first client over the local area network or the second client over the wide area network based on the modifying during the presenting.

13. The system of claim 11, wherein the financial data sets do not have a security identifier in common during at least one of the defining or the modifying.

14. The system of claim 11, wherein the cores are dedicated to processing the financial data sets in a one-to-one manner during at least one of the retrieving, the populating the first data structure with the financial data sets, or the modifying.

15. The system of claim 11, wherein the modifying comprises replacing an original member of at least one of the financial data sets with a new member.

16. The system of claim 11, wherein the read access is a first read access, wherein the server is configured to:
in response to the defining, generate a third data structure comprising the financial data set identifiers and the financial data sets obtained from the first data structure, wherein the financial data set identifiers in the third data structure correspond to the financial data sets in a one-to-one manner;
modify, based on the generating, at least one of the financial data sets in the third data structure based on a change in at least one of the financial data sets, the first data structure based on the rule sets in the second data structure, and the event messages as interpreted;
grant, over the wide area network, a second read access to the second client, wherein the second read access is for the third data structure.

17. The system of claim 11, wherein the data sources pushes the event messages onto the server.

18. The system of claim 11, wherein the server pulls the event messages from the data source.

19. The system of claim 11, wherein the financial data sets and the index are embodied via a linked list within the first data structure, wherein the index links to the financial data sets.

20. The system of claim 11, wherein the financial data sets and the index are embodied via a tree within the first data structure, wherein the financial data sets branch to the index.
